(19) United States
(12) Patent Application Publication
(10) Pub. No.: US 2014/0074994 A1
(43) Pub. Date: Mar. 13, 2014

(54) GATEWAY APPARATUS, COMMUNICATION METHOD OF GATEWAY APPARATUS, NODE APPARATUS, COMMUNICATION METHOD OF NODE APPARATUS, AND COMMUNICATION SYSTEM

(71) Applicant: FUJITSU LIMITED, Kawasaki-shi (JP)

(72) Inventors: Takeo HONDA, Nagoya (JP); Katsuyuki MATSUNAGA, Inuyama (JP); Katsumi SAKURAI, Kamo (JP); Seiichi KAWASHIMA, Yokohama (JP); Satoshi KASAI, Yokohama (JP); Kazuya KAWASHIMA, Fukuoka (JP); Tetsu YAMAMOTO, Fukuoka (JP); Tadashige IWAO, Kawasaki (JP)

(73) Assignee: FUJITSU LIMITED, Kawasaki-shi (JP)

(21) Appl. No.: 14/080,426

(22) Filed: Nov. 14, 2013

Related U.S. Application Data
(63) Continuation of application No. PCT/JP2011/061534, filed on May 19, 2011.

(51) Int. Cl. H04L 29/06

(52) U.S. Cl. CPC H04L 69/18
USPC 709/219

(57) ABSTRACT

A gateway apparatus includes a sorting destination storing unit which stores information of a sorting destination that performs a process according to a destination, a sorting unit which outputs an input destination and transmission data to a sorting destination according to the destination searched from information stored in the sorting destination storing unit, a transmission destination storing unit which stores information of a transmission destination for each destination, an input/output unit which performs a transmission process and a reception process according to a corresponding protocol stack, and a protocol converting unit which assembles, when a destination and transmission data are input from the sorting unit, the destination and the transmission data as data that matches a format of a corresponding protocol stack, and instructs the input/output unit of a corresponding protocol stack to transmit the assembled data to a transmission destination according to the destination.

### CROSS-REFERENCE TO RELATED APPLICATIONS

This application is a continuation application of International Application PCT/JP2011/061534 filed on May 19, 2011 and designated the U.S., the entire contents of which are incorporated herein by reference.

### FIELD

The present invention relates to a technique to perform communication in networks constituted by node apparatuses of different communication protocols and protocol stacks.

### BACKGROUND

Conventionally, communication has been performed between networks with different communication protocols.

For example, in a system including a sensor network that performs collection of sensor data and the like, a server apparatus of a data center that performs aggregation of collected sensor data and the like, communication is performed between the sensor network and the large-scale network including the server apparatus of the data center. Here, the sensor network is a network in which a plurality of sensors and different sensors are mounted on sensor-attached node apparatuses, and the node apparatuses cooperate in an autonomous-distributed manner to make the communication possible. The node apparatus of the sensor networks has many hardware restrictions, and are required to be small and be able to be driven for a long time by a battery, for example. As the communication protocol, for example, ZigBee (registered trademark) is used as a communication protocol. On the other hand, in a large network, the Internet protocol suite (TCP (Transmission Control Protocol)/IP (Internet Protocol) Protocol Suite) is the standard.

ZigBee and Internet Protocol Suite are different communication protocols and mutual communication is not available. Therefore, in order to perform communication between a plurality of different communication protocols, there is a need to understand the communication protocol used for each destination node in advance, and to perform communication protocol conversion corresponding to the destination node apparatus by an application (application software). FIG. 37 illustrates a configuration example of the conventional art in a case the communication protocol conversion is realized by an application.

For example, when converting between ZigBee and Internet Protocol Suite, first, an application to perform protocol conversion from ZigBee to Internet Protocol Suite (or vice versa) is created. Next, an attention is paid to the ZigBee network. In addition, an attention is also paid to the network of the Internet Protocol Suite in the same manner. Then, anode apparatus (gateway for example) on which the communication protocol conversion application is implemented is disposed on the boundary of the both networks. The application run on the gateway recognizes the communication protocol received from one of the networks and converts into the protocol of the other when the destination node apparatus is of a different communication protocol, to perform communication between networks of different types. That is, when performing communication with different protocol stacks, there is a need for disposing a node apparatus on which the communication protocol conversion application is implemented, and for a setting work for all the node apparatuses participating in the network to correct the routing table so as to go through the node apparatus.

Meanwhile, regarding the virtualization technique of the communication protocol, a technique as follows has been known.

For example, an abstraction layer of software or hardware is added between layer 6 and layer 7 of the OSI (Open Systems Interconnection) reference model, to virtualize the network. Meanwhile, a technique to attain automatic tunneling between networks of different types has also been known. Furthermore, a technique to enable communication even when a terminal moves to a network of a different communication protocol has also been known.

Meanwhile, techniques described in the respective documents below have been known.
[Patent document 1] Japanese Laid-open Patent Publication No. 2003-208365
[Patent document 2] Japanese National Publication of International Patent Application No. 2004-515165
[Patent document 3] Japanese National Publication of International Patent Application No. 2007-515822

When performing communication between networks with different communication protocols, conventionally, there is a need to perform communication in consideration of the communication protocol. That is, when the destination node apparatus and the transmission source node apparatus use different communication protocols, first, it needs to be understood that the respective node apparatuses belong to networks of different communication protocols in advance, and a node apparatus having the communication protocol conversion function on which the conversion application of communication protocols is run needs to be disposed. Furthermore, a path control such as to edit the routing table so as to go through the node apparatus is needed, for the communication path from the transmission source node apparatus to the destination node apparatus.

In the priori arts, assuming a node apparatus on which Internet Protocol Suite is implemented, protocol abstraction is performed in the same layer on or above the network layer and on or below the presentation layer of the OSI reference model. However, for example, ZigBee does not assume the Internet Protocol. Therefore, in the sensor network, it is impossible to apply the prior art. However, in the sensor network, it may be desired that different protocols are present in a mixed manner according to the characteristics of hardware, other than ZigBee. In such a case, there has been a problem that what communication protocols exist between the destination node and the transmission source node needs to be understood in advance, and furthermore, a node apparatus having a plurality of communication protocol conversion function needs to be disposed on the boundary of the different networks, and a path control means to go through the node apparatus needs to be set in each node apparatus, requiring complicated network settings.

### SUMMARY

According to an aspect of the embodiment, a gateway apparatus in which a plurality of protocol stacks are implemented and configured to mediate communication between a server apparatus and a node apparatus, in a communication system including a server apparatus, a node apparatus and a gateway apparatus, the gateway apparatus includes a sorting destination storing unit, a sorting unit, a transmission destination storing unit, an input/output unit, and a protocol converting unit. The sorting destination storing unit stores information of a sorting destination that performs a process according to a destination, for each destination. The sorting unit outputs an input destination and transmission data to a sorting destination according to the destination searched from information stored in the sorting destination storing unit. The transmission destination storing unit stores information of a transmission destination for each destination. The input/output unit is provided for each implemented protocol stack and performs a transmission process and a reception process according to a corresponding protocol stack. The protocol converting unit is provided for each implemented protocol stack and assembles, when a destination and transmission data are input from the sorting unit, the destination and the transmission data as data that matches a format of a corresponding protocol stack, and instructs the input/output unit of a corresponding protocol stack to transmit the assembled data to a transmission destination according to the destination searched from information stored in the transmission destination storing unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a sensor data processing system that performs communication between two networks with different communication protocols.

FIG. 2 is a diagram illustrating an example of a large scale sensor data processing system in which communication is performed between four networks with different communication protocols.

FIG. 3 is a diagram illustrating an example of a system according to an embodiment.

FIG. 4 is a diagram illustrating an example of connection relationship between the respective server apparatuses, the gateway apparatus and the respective node apparatuses.

FIG. 5 is a diagram illustrating a configuration example of each server apparatus.

FIG. 6 is a diagram illustrating a configuration example of a gateway apparatus.

FIG. 7 is a diagram illustrating a configuration example of each node apparatus.

FIG. 8 is a flowchart illustrating an operation example of each process sorting unit.

FIG. 9 is a flowchart illustrating an operation example of each protocol conversion processing unit.

FIG. 10 is a diagram illustrating a processing example of S203 and S204.

FIG. 11 is a flowchart illustrating an operation example of each transmission destination searching unit.

FIG. 12 is an example of information stored in a process sorting DB and a transmission destination conversion DB of a server apparatus.

FIG. 13 is an example of information stored in a process sorting DB and a transmission destination conversion DB of a gateway apparatus.

FIG. 14 is an example of information stored in a process sorting DB and a transmission destination conversion DB of a node apparatus.

FIG. 15 is a diagram illustrating an example of a process sequence of the overall system when a new node apparatus is added.

FIG. 16 is a diagram illustrating an example of a process sequence of a newly added node apparatus.

FIG. 17 is a diagram illustrating an example of a process sequence of a gateway apparatus.

FIG. 18 is a diagram illustrating a process sequence of a management server apparatus.

FIG. 19 is a diagram illustrating a process sequence of an apparatus being the transmission destination of data transmitted from a management server apparatus.

FIG. 20 is a first diagram illustrating another configuration example of a system according to an embodiment.

FIG. 21 is a second diagram illustrating another configuration example of a system according to an embodiment.

FIG. 22 is a third diagram illustrating another configuration example of a system according to an embodiment.

FIG. 23 is a diagram illustrating a configuration example of a gateway apparatus in a case of supporting three types or more of communication protocols.

FIG. 24 is a diagram illustrating a configuration example of a gateway apparatus in a case of supporting two types of communication protocols with the same physical later but with different protocol stacks.

FIG. 25 is a diagram illustrating a configuration example of a gateway apparatus in a case in which the communication protocol to support is one type but a plurality of communication units are provided.

FIG. 26 is a diagram illustrating a configuration example of a gateway apparatus in a case in which the configuration examples illustrated in FIG. 23 and FIG. 24 are combined.

FIG. 27 is a diagram illustrating a configuration example of a node apparatus in a case in which a part of the configuration is made into a chip.

FIG. 28 is a diagram illustrating a configuration example of a node apparatus in a case in which a part of the configuration is made into a communication module.

FIG. 29 is a diagram illustrating an example in which a system according to an embodiment is applied to the environment management of a data center.

FIG. 30 is a diagram illustrating an example in which two core relay nodes transmit sensing data to a monitoring server while sharing roles.

FIG. 31 is a diagram illustrating a control sequence of FIG. 30.

FIG. 32 is a diagram illustrating a configuration diagram of each server apparatus, a gateway apparatus, each node apparatus included in a system according to a variation example.

FIG. 33 is a first flowchart illustrating an operation example of each IP protocol processing unit.

FIG. 34 is a second flowchart illustrating an operation example of each IP protocol processing unit.

FIG. 35 is a diagram illustrating another configuration diagram of each server apparatus, a gateway apparatus, each node apparatus included in a system according to a variation example.

FIG. 36 is a diagram illustrating a configuration example of a computer system.

FIG. 37 is a diagram illustrating a configuration example of a conventional art in which communication protocol conversion is realized by an application.

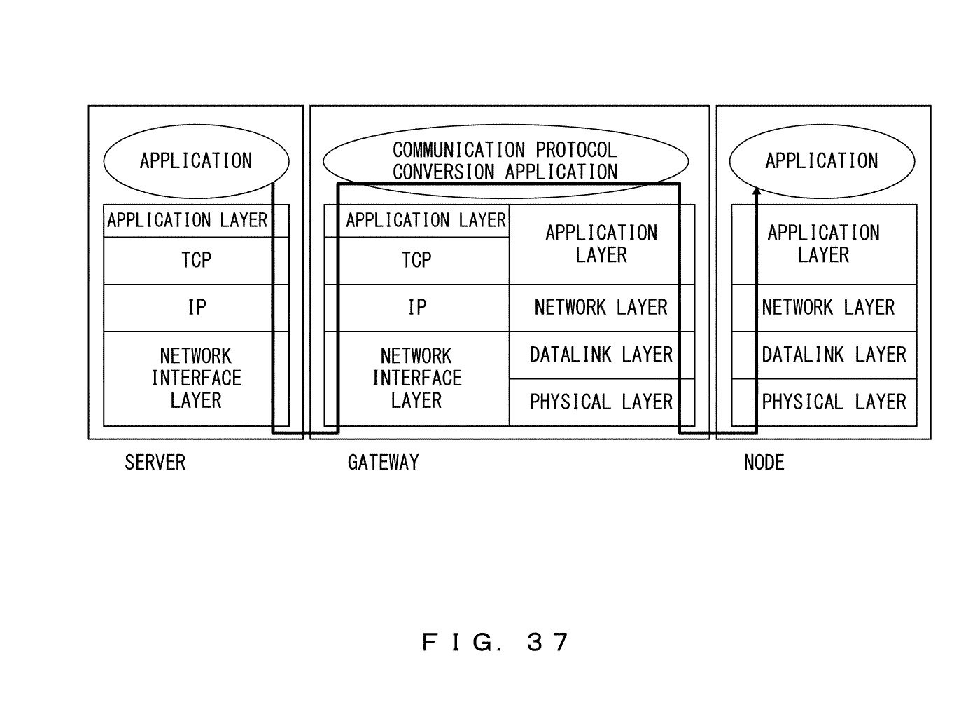

### DESCRIPTION OF EMBODIMENTS

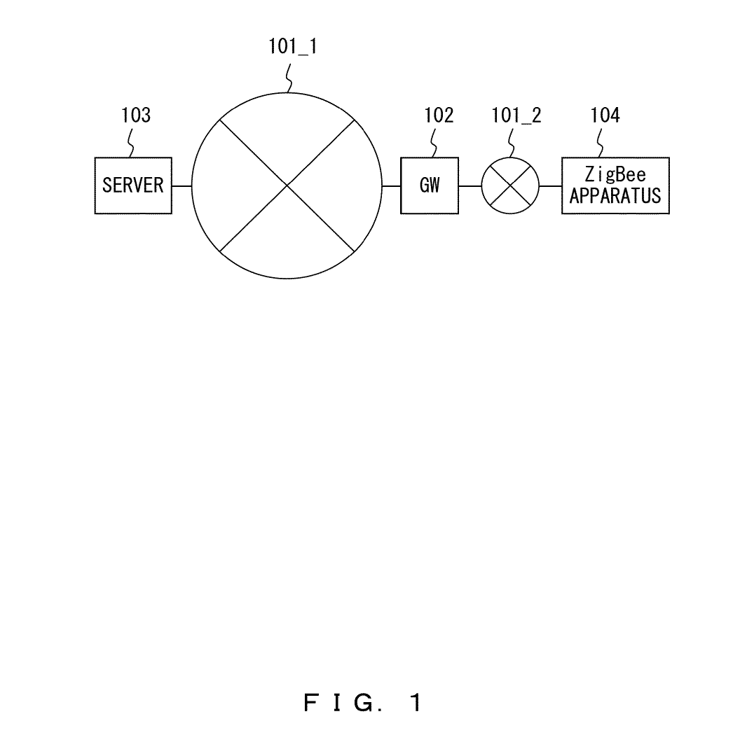

FIG. 1 illustrates an example of a sensor data processing system that performs communication between two networks with different communication protocols.

In the system illustrated in FIG. 1, two networks 101 (101_1, 101_2) with different communication protocols are connected via a gateway apparatus (GW) 102. The network 101_1 is a large scale network including a server apparatus 103 of a data center, and Internet Protocol Suite is used as the communication protocol. The network 101_2 is a small scale sensor network constituted of about several dozen to a hundred sensor node apparatuses (ZigBee apparatuses) 104, and ZigBee is used as the communication protocol.

Meanwhile, in a sensor network, there is a case in which wired connection is not available and a use of wireless is needed, depending on the placement environment of the sensor. In addition, there is also a case in which battery-driven operation, and operation of several dozen years is desired. In such a case, it is impossible to adopt the use of TCP/IP by wireless LAN as the communication protocol on the ground that the battery life will be shortened. Therefore, in such a case, a unique communication protocol such as ZigBee that enables wireless communication with small power consumption is used.

In the system illustrated in FIG. 1, for example, a process in which sensor data collected by each sensor node apparatus 104 are aggregated by the server apparatus 103 of the data center, and the like, is performed.

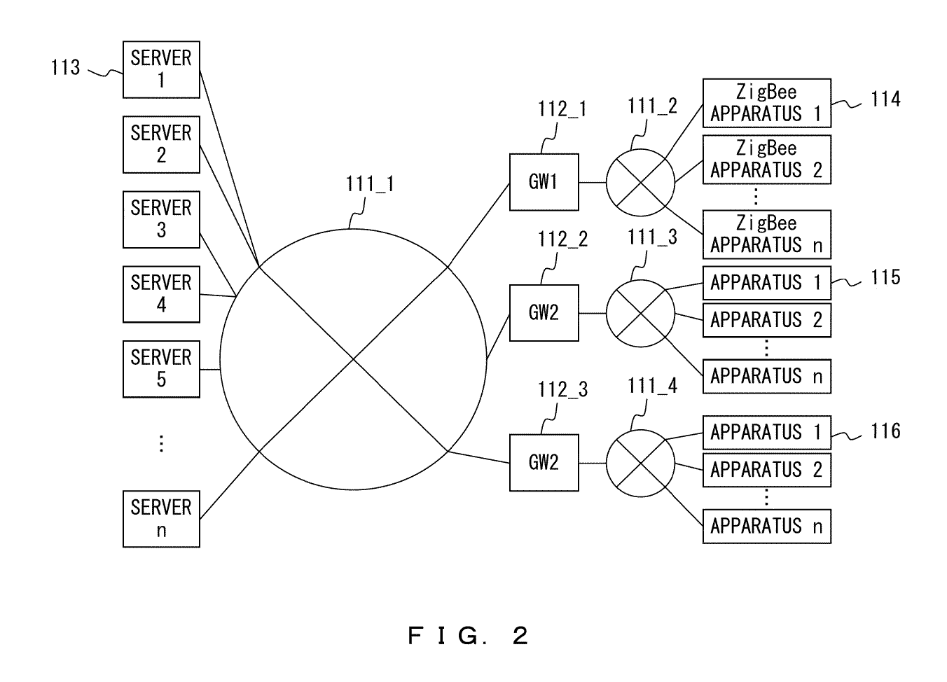

FIG. 2 illustrates an example of a large scale sensor data processing system in which communication is performed between four networks with different communication protocols.

The system illustrated in FIG. 2 is a system in which a plurality of sensor networks constituted by around several thousand units of sensor node apparatuses are connected, to process sensor data by a plurality of server apparatuses of the data center, on the background that the sensor network has become larger and more diversified.

In the system illustrated in FIG. 2, four networks 111 (111_1, 111_2, 111_3, 111_4) with different communication protocol are connected via three gateway apparatuses 112 (112_1, 112_2, 112_3). That is, the networks 111_1 and 111_2 are connected via the gateway apparatus 112_1. Meanwhile, the networks 111_1 and 111_3 are connected via the gateway apparatus 112_2. Meanwhile, the networks 111_1 and 111_4 are connected via the gateway apparatus 112_3. The network 111_1 is a large scale network including a plurality of server apparatuses 113 of the data center, and Internet Protocol Suite is used as the communication protocol. The network 111_2 is a sensor network constituted by a plurality of sensor node apparatuses (ZigBee apparatuses) 114, and ZigBee is used as the communication protocol. The network 111_3 is a sensor network constituted by a plurality of sensor node apparatuses 115, where a different communication protocol from those of the networks 111_1, 111_2 is used. The network 111_4 is a sensor network constituted by a plurality of sensor node apparatuses 116, where a different communication protocol from those of the networks 111_1, 111_2, 111_3 are used.

In the system illustrated in FIG. 2, for example, sensor data collected in the sensor networks 111_2, 111_3, 111_4 are processed by a plurality of server apparatuses 113 of the data center in a shared manner.

As in the system illustrated in FIG. 1 and FIG. 2, in a system in which communication is performed between networks with different communication protocols, when applying the conventional art, the communication needs to be performed in consideration of the communication protocols. For example, in the conventional art, gateway apparatus 102 in FIG. 1 and the gateway apparatus 112_1 in FIG. 2 need to perform conversion between ZigBee and Internet Protocol. These gateway apparatuses are equipped with ZigBee and Internet Protocol as known in advance, and are further equipped with an application to convert the both communication protocols. In the conventional art, since ZigBee and Internet Protocol are not compatible, a conversion application to convert the both protocols is needed.

However, what is desirable in such a system is to be able to perform communication without consideration of the communication protocols. In addition, even when the combination of networks with different communication protocols is different, to be able to perform communication in the same manner without consideration of the communication protocols.

Therefore, in a system according to an embodiment makes it possible to perform communication without consideration of the actual communication protocols, as explained in detail below, by realizing a virtual network by abstracting a plurality of communication protocols used in a plurality of networks.

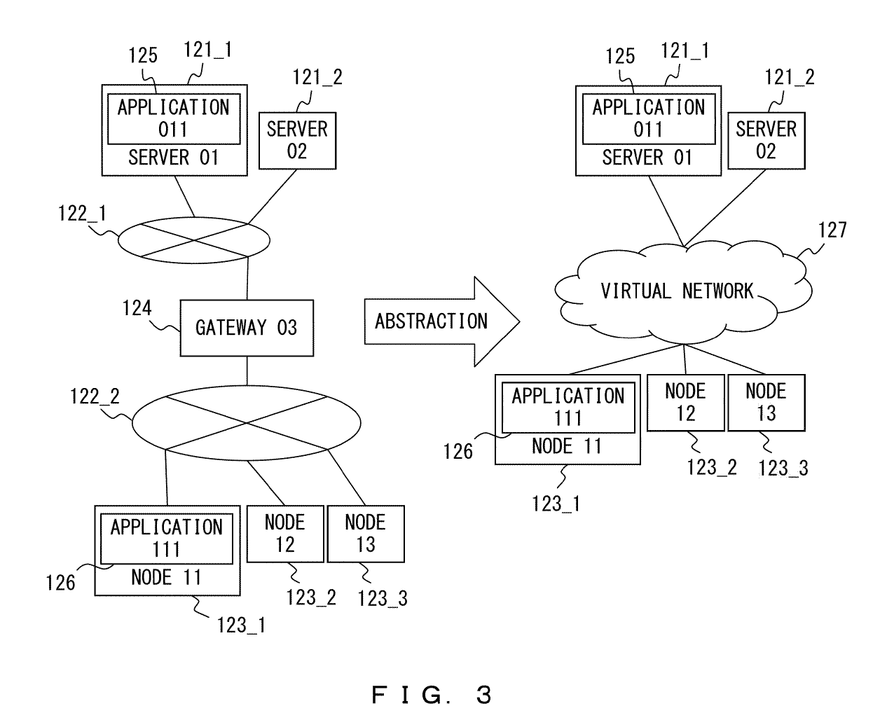

FIG. 3 illustrates an example of a system according to the present embodiment.

In the system illustrated in FIG. 3, a network 122_1 including two server apparatuses 121 (121_1, 121_2) and a network 122_2 including three node apparatuses 123 (123_1, 123_2, 123_3) are connected via a gateway apparatus 124. In the network 122_1, the communication protocol of the first protocol stack is used. In this example, the first protocol stack is assumed as Internet Protocol stack. Therefore, in the network 122_1, Internet Protocol Suite is used as the communication protocol. In the network 122_2, the communication protocol of the second protocol stack that is different from the first protocol stack is used. The gateway apparatus 124 is able to communicate with the two server apparatuses 121 by the communication protocol of the network 122_1, and is able to communicate with the three node apparatuses 123 by the communication protocol of the network 122_2.

In the system illustrated in FIG. 3, for example, when an application 125 of the server apparatus 121_1 performs transmission/reception of a message with an application 126 of the node apparatus 123_1, conventionally, there is a need to consider the type of the communication protocol.

In contrast, according to the present embodiment, while details are described later, by abstracting the communication protocols of the two networks 122, a virtual network 127 may be realized. In this case, in the environment, two server apparatuses 121_1 and the three node apparatuses 123 are connected. Therefore, the application 125 of the server apparatus 121_1 is able to perform transmission/reception of a message with the application 126 of the node apparatus 123_1 without distinguishing the actual communication protocols. That is, in the system according to the present embodiment, each apparatus is able to perform communication with each of the other apparatuses without consideration of the actual communication protocols.

In the system according to the present embodiment, in order to realize such a virtual network, a function to convert protocols (hereinafter, referred to as “network middleware”) is introduced in each apparatus of the respective server apparatuses 121, the gateway apparatus 124, the respective node apparatuses 123.

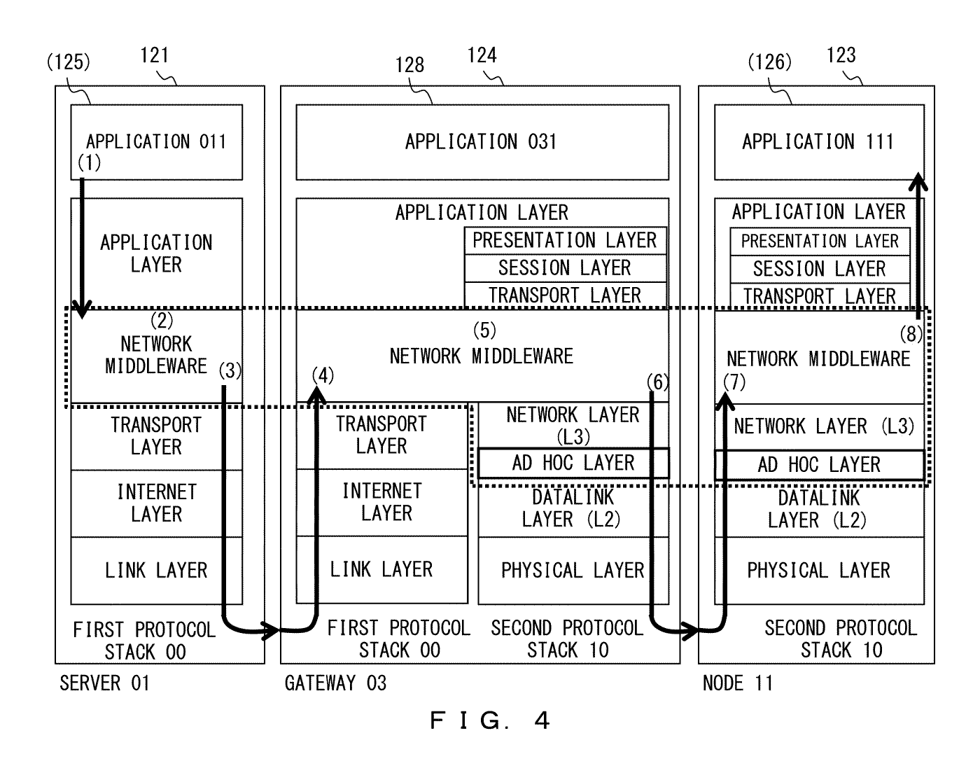

FIG. 4 illustrates an example of the connection relationship of the respective server apparatuses 121, the gateway apparatus 124, the respective node apparatuses 123, in the system according to the present embodiment.

In the example illustrated in FIG. 4, of the two different protocol stacks, the second protocol stack is the protocol stack of the wireless ad-hoc communication protocol. The wireless ad-hoc communication protocol has a function of the ad-hoc routing protocol to form an ad-hoc network, and mainly performs communication status management, data transmission/reception, routing (management of the communication path of data) between the communication terminals. It corresponds to a part of the datalink layer being the second layer and the network layer being the third layer of the OSI reference model. In this case, it is described as a layer (ad-hoc layer) to perform an ad-hoc process between the datalink layer and the network layer, in the second protocol stack. The wireless ad-hoc communication protocol is a communication protocol in which the path is controllable in the ad-hoc layer, and the hierarchy of the network layer of the ad-hoc layer and above does not have to be defined. Meanwhile, in the second protocol stack, the network layer is described to make the layer structure of the protocol stack consistent.

As illustrated in FIG. 4, in each server apparatus 121, the first protocol stack is implemented, in each node apparatus 123, the second protocol stack is implemented, and in the gateway apparatus 124, both of the protocol stacks are implemented. Then, the network middleware is disposed in the protocol stack implemented in each apparatus. That is, in each server apparatus 121, the network middleware is disposed between the transport layer and the application layer in the first protocol stack. In the gateway apparatus 124, the network middleware is disposed between the transport layer and the application layer in the first protocol stack, and between the network layer and the transport layer of the second protocol stack. In each node apparatus 123, the network middleware is disposed between the network layer and the transport layer in the second protocol stack. Meanwhile, in each server apparatus 121, the gate apparatus 124, each node apparatus 123, the range that is abstracted by the network middleware is the part enclosed with the dotted line in FIG. 4.

In FIG. 4, (1) through (8) illustrate the flow of the process when the application 125 of the server apparatus 121_1 transmits a message to the application 126 of the node apparatus 123_1, for example. This will be described later.

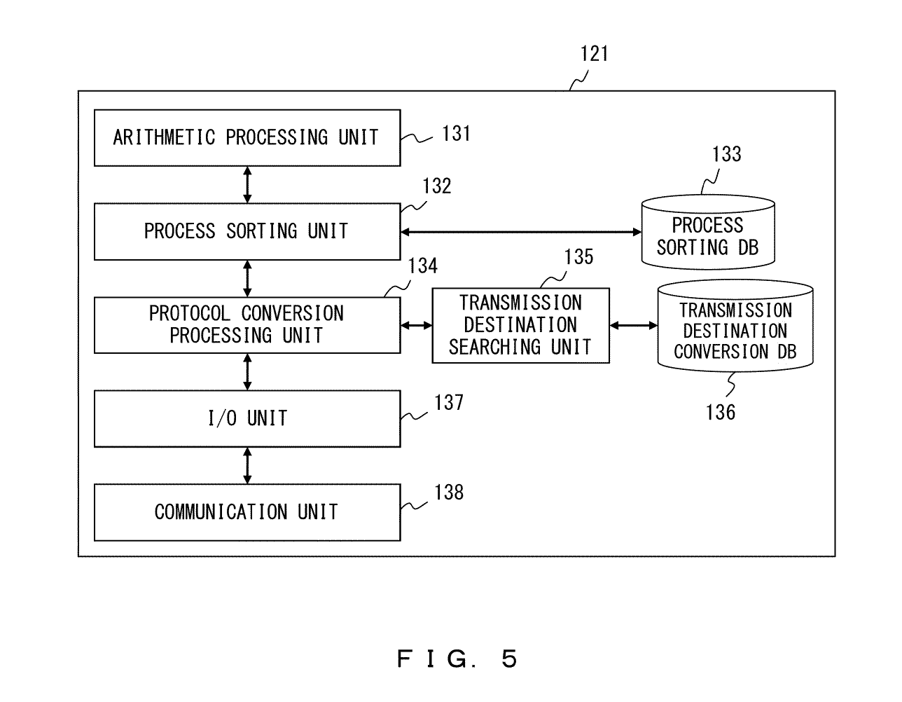

FIG. 5 illustrates a configuration example of each server apparatus 121.

As illustrated in FIG. 5, each server apparatus 121 includes an arithmetic processing unit 131, a process sorting unit 132, a process sorting DB (DataBase) 133, a transmission destination searching unit 135, a transmission destination conversion DB (DataBase) 136. Meanwhile, each server apparatus 121 includes a protocol conversion processing unit 134, an I/O (Input/Output) unit 137, a communication unit 138 for the first protocol stack. Here, the network middleware corresponds to the process sorting unit 132, protocol conversion processing unit 134, and the transmission destination searching unit 135, and the like.

The arithmetic processing unit 131 executes the program of various applications such as the application 125.

Upon receiving a destination and transmission data from an application run on the arithmetic processing unit 131 or the protocol conversion processing unit 134, the process sorting unit 132 refers to the process sorting DB 133, and sorts the destination and the transmission data into the sorting destination that performs the process according to the destination. As the sorting destination, various components are possible, such as application software run on the arithmetic processing unit 131, the protocol conversion processing unit 134, and the like.

The process sorting DB 133 stores information to specify the sorting destination for each destination (information of the sorting destination for each destination).

Upon receiving the destination and the transmission data from the process sorting unit 132, the protocol conversion processing unit 134 makes an inquiry to the transmission destination searching unit 135 about the transmission destination according to its destination. In addition, the protocol conversion processing unit 134 assembles the destination and the transmission data received from the processing sorting unit 132 as data that match the format of the first protocol stack, and instructs the I/O unit 137 to transmit it to the transmission destination according its destination. Meanwhile, upon receiving data from the I/O unit 137, the protocol conversion processing unit 134 takes out, from the data the destination and the transmission data (data to pass to the application of the destination), and pass them, to the process sorting unit 132.

Upon receiving an inquiry about the transmission destination according to the destination from the protocol conversion processing unit 134, the transmission destination searching unit 135 refers to the transmission destination conversion DB 136, searches for the transmission destination according to the destination, and replies with the search result.

The transmission destination conversion DB 136 stores information that specifies the transmission destination for each destination (information of the transmission destination for each destination).

The I/O unit 137 is a driver for TCP/IP for example, and upon receiving an instruction from the protocol conversion processing unit 134, performs a transmission process according to the first protocol stack according to the instruction, to transmit data to the transmission destination from the communication unit 138. Meanwhile, the communication unit 138 is an Ethernet (registered trademark) board for example. In addition, when the communication unit 138 receives the data, the I/O unit 137 performs a reception process for the data according to the first protocol stack, and passes the obtained data to the protocol conversion processing unit 134.

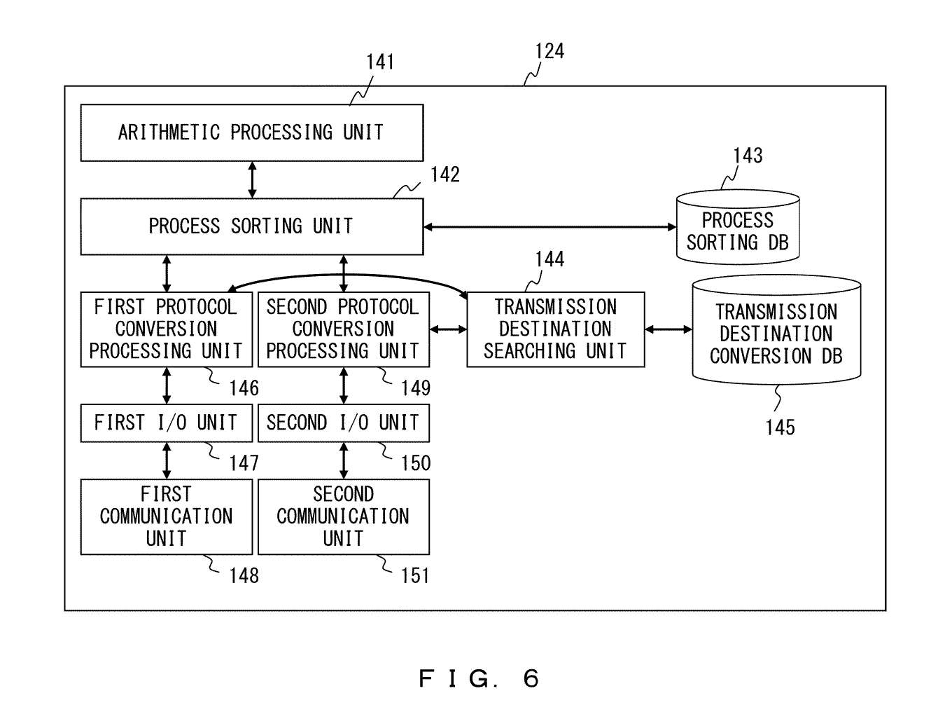

FIG. 6 illustrates a configuration diagram of the gateway apparatus 124.

As illustrated in FIG. 6, the gateway apparatus 124 includes an arithmetic processing unit 141, a process sorting unit 142, a process sorting DB (DataBase) 143, a transmission destination searching unit 144, a transmission destination conversion DB (DataBase) 145. Meanwhile, the gateway apparatus 124 includes a first protocol conversion processing unit 146, a first I/O (Input/Output) unit 147, a first communication unit 148 for the first protocol stack. Meanwhile, the gateway apparatus 124 includes a second protocol conversion processing unit 149, a second I/O (Input/Output) unit 150, a second communication unit 151 for the second protocol stack. Here, the network middleware corresponds to the process sorting unit 142, the first and second protocol conversion processing units 149, 149 and the transmission destination searching unit 144, and the like.

Meanwhile, the process sorting unit 142 is an example of the sorting unit, and is also an example of the third sorting unit. The process sorting DB 143 is an example of a sorting destination storing unit, and is also an example of the third sorting destination storing unit. The transmission destination conversion DB 145 is an example of the transmission destination storing unit, and is also an example of the third transmission destination storing unit. The first protocol conversion processing unit 146 and the second protocol conversion processing unit 149 are an example of the protocol converting unit, while the first protocol conversion processing unit 146 is also an example of the third protocol converting unit, and the second protocol conversion processing unit 149 is also an example of the fourth protocol converting unit. The first I/O unit 147 and the second I/O unit 150 are an example of the input/output unit, while the first I/O unit 147 is also an example of the third input/output unit, and the second I/O unit 150 is also an example of the fourth input/output unit.

The arithmetic processing unit 141 executes the program of various applications.

Upon receiving the destination and the transmission data from an application run on the arithmetic processing unit 141, the first protocol conversion processing unit 146, or the second protocol conversion processing unit 149, the process sorting unit 142 refers to the process sorting DB 143, and sorts the destination and the transmission data into the sorting destination according to its destination.

The process sorting DB 143 stores information that specifies the sorting destination for each destination (information of the sorting destination for each destination).

Upon receiving destination and transmission data from the process sorting unit 142, the first protocol conversion processing unit 146 makes an inquiry to the transmission destination searching unit 144 about the transmission destination according to the destination. Meanwhile, the first protocol conversion processing unit 146 assembles the destination and the transmission data received from the process sorting unit 142 as data that matches the format of the first protocol stack, and instructs the first I/O unit 147 to transmit it to the transmission destination according to the destination. Meanwhile, upon receiving the data from the first I/O unit 147, the first protocol conversion processing unit 146 takes out the destination and the transmission data (data to pass to the application of the destination), from the data, and passes them, to the process storing unit 142.

Upon receiving the destination and the transmission data from the process sorting unit 142, the second protocol conversion processing unit 149 makes an inquiry to the transmission destination searching unit 144, about the transmission destination according to the destination. Meanwhile, the second protocol conversion processing unit 149 assembles the destination and the transmission data received from the process sorting unit 142 as data that matches the format of the second protocol stack, and instructs the second I/O unit 150 to transmit it to the transmission destination according to the destination. Meanwhile, upon receiving data from the second I/O unit 150, the second protocol conversion processing unit 149, takes out the destination and the transmission data (data to pass to the application of the destination), from the data, and pass them, to the process sorting unit 142.

Upon receiving an inquiry about the transmission destination according to the destination from the first protocol conversion processing unit 146 or the second protocol conversion processing unit 149, the transmission destination searching unit 144 refers to the transmission destination conversion DB 145, searches for the transmission destination according to the destination, and replies with the search result.

The transmission destination conversion DB 145 stores information that specifies the transmission destination for each destination (information of the transmission destination for each destination).

The first I/O unit 147 is a driver for TCP/IP, for example, and upon receiving an instruction from the first protocol conversion processing unit 146, according to the instruction, performs a transmission process according to the first protocol stack, to transmit data from the first communication unit 148 to the transmission destination. Meanwhile, the first communication unit 148 is, for example, an Ethernet (registered trademark) board. Meanwhile, when the first communication unit 148 receives data, the, first I/O unit 147 performs a reception process for the data according to the first protocol stack, and passes the obtained data to the first protocol conversion processing unit 146.

The second I/O unit 150 is, for example, a driver for wireless ad-hoc communication protocol, and upon receiving an instruction from the second protocol conversion processing unit 149, according to the instruction, performs a transmission process according to the second protocol stack, to transmit the data from the second communication unit 151 to the transmission destination. Meanwhile, the second communication unit 151 is a wireless communication module for example. Meanwhile, when the second communication unit 151 receives data, the second I/O unit 150 performs a reception process for the data according to the second protocol stack, and passes the obtained data to the second protocol conversion processing unit 149.

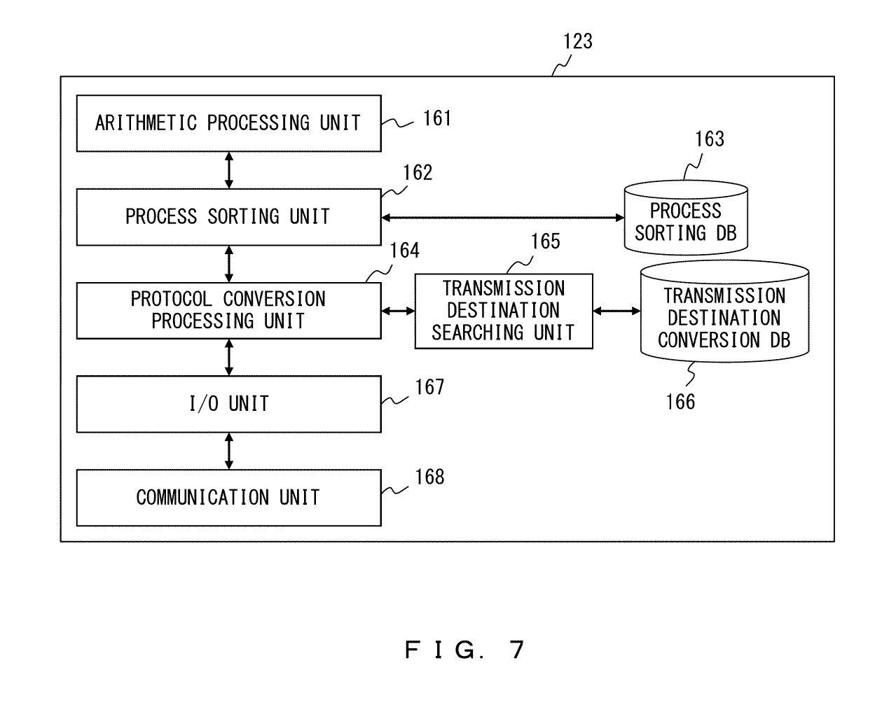

FIG. 7 illustrates a configuration example of each node apparatus 123.

As illustrated in FIG. 7, each node apparatus 123 includes an arithmetic processing unit 161, a process sorting unit 162, a process sorting DB (DataBase) 163, a transmission destination searching unit 165, a transmission destination conversion DB (DataBase) 166. In addition, each node apparatus 123 includes a protocol conversion processing unit 164, an I/O (Input/Output) unit 167, a communication unit 168 for the second protocol stack. Here, the network middleware corresponds to the process sorting unit 162, protocol conversion processing unit 164, and the transmission destination searching unit 165, and the like.

Meanwhile, the process sorting unit 162 is an example of the sorting unit, and is also an example of the second sorting unit. The process sorting DB (Data Base) 163 is an example of the sorting destination storing unit, and is also an example of the second sorting destination storing unit. The transmission destination conversion DB 166 is an example of the transmission destination storing unit, and is also an example of the second transmission destination storing unit. The protocol conversion processing unit 164 is an example of the protocol converting unit, and is also an example of the second protocol conversion unit. The I/O unit 167 is an example of the input/output unit, and is also an example of the second input/output unit.

The arithmetic processing unit 161 executes the program of various applications such as the application 126, for example.

Upon receiving the destination and the transmission data from the application run on the arithmetic processing unit 161 or protocol conversion processing unit 164, the process sorting unit 162 refers to the process sorting DB 163, and sorts the destination and the transmission data to the sorting destination according to the destination.

The process sorting DB 163 stores the information that specifies the sorting destination for each destination (information of the sorting destination for each destination).

Upon receiving the destination and the transmission data from the process sorting unit 162, the protocol conversion processing unit 164 makes an inquiry to the transmission destination searching unit 165 about the transmission destination according to the destination. Meanwhile, the protocol conversion processing unit 164 assembles the destination and the transmission data received from the process sorting unit 162 as data that match the format of the second protocol stack, and instructs the I/O unit 167 to transmit it to the transmission destination according to the destination. Meanwhile, upon receiving data from the I/O unit 167, the protocol conversion processing unit 164 takes out the destination and the transmission data (data to pass to the application of the destination), from the data, and pass them, to the process sorting unit 162.

Upon receiving an inquiry from the protocol conversion processing unit 164 about the transmission destination according to the destination, the transmission destination searching unit 165 refers to the transmission destination conversion DB 166, searches for the transmission destination according to the destination, and replies with the search result.

The transmission destination conversion DB 166 stores information that specifies the transmission destination for each destination (information of the transmission destination for each destination).

The I/O unit 167 is, for example, a driver for wireless ad-hoc communication protocol, and upon receiving an instruction from the protocol conversion processing unit 164, according to the instruction, performs a transmission process according to the second protocol stack, to transmit data from the communication unit 168 to the transmission destination. Meanwhile, the communication unit 168 is a wireless communication module for example. Meanwhile, when the communication unit 168 receives data, the I/O unit 168 performs a reception process for the data according to the second protocol stack, and passes the obtained data to the protocol conversion processing unit 164.

In each server apparatus 121, the gateway apparatus 124, each node apparatus 123, the respective DBs, the process sorting DBs 133, 143, 163 store information that specifies the sorting destination, as described above. There, the destination is the ultimate destination of the data, and is an application of the local apparatus or another apparatus.

The application of the local apparatus or another apparatus is, for example, identified by the ID (Identifier) of the local apparatus or the another apparatus and the ID of the application. Meanwhile, the information of the destination may be stored as information of an individual destination, and may also be stored as information of the pattern of the destination name using regular expression and the like. The sorting destination is a module that processes transmission data to the destination, and is an application of the local apparatus, or the protocol conversion processing unit. The application of the local apparatus and the protocol conversion processing unit is identified by, for example, the ID of the application of the local apparatus, and by the ID of the protocol conversion processing unit.

Meanwhile, the respective DBs, the transmission destination conversion DBs 136, 145, 166 store information that specifies the transmission destination for each destination. Here, the destination is the ultimate destination of the data, and is an application of the local apparatus or another apparatus. The application of the local apparatus or another apparatus is, for example, identified by the ID of the local apparatus or another apparatus and the ID of the application. Meanwhile, the information of the destination may be stored as information of an individual destination, and may also be stored as information of the pattern of the destination name using regular expression and the like. In addition, the transmission destination is an apparatus within a communicable range by the communication protocol of the implemented protocol stack.

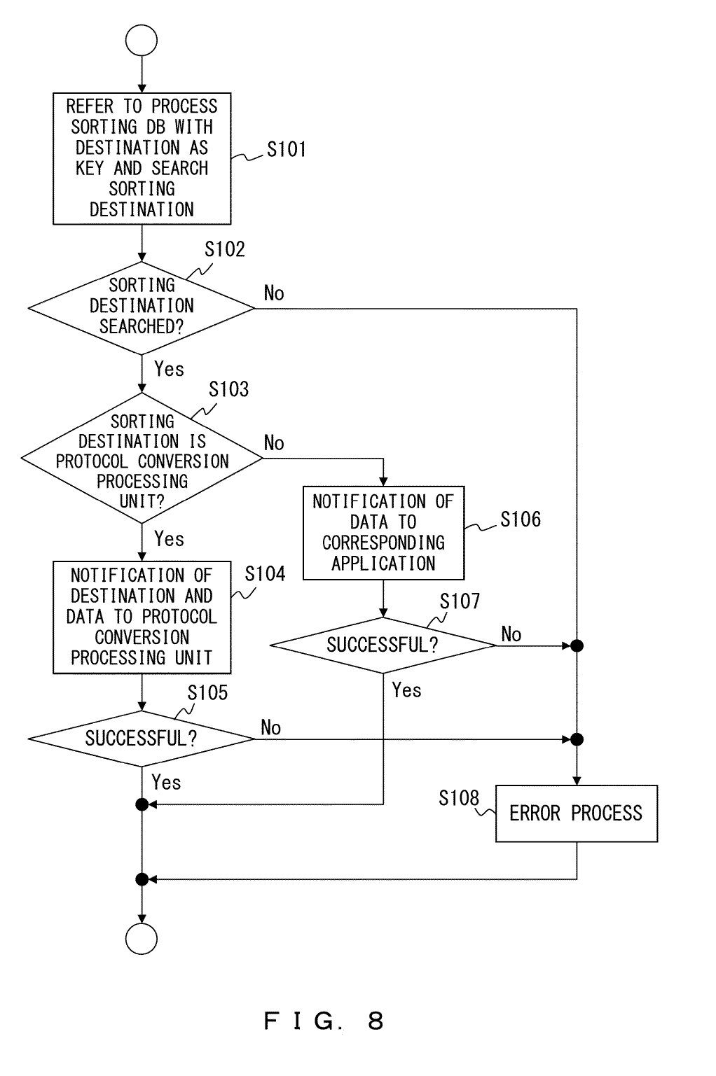

FIG. 8 is a flowchart illustrating an operation example of the respective process sorting units 132, 142, 162. Meanwhile, the operations of the respective units are the same operation in corresponding apparatuses.

As illustrated in FIG. 8, when the destination and transmission data are input, each process sorting unit performs the following process.

First, referring to the process sorting DB, the sorting destination is searched with the input destination as the search key (S101), and whether or not the sorting destination corresponding to the destination has been searched is judged (S102).

When the judgment result in S102 is Yes, whether or not the searched sorting destination is a protocol conversion processing unit is judged (S103). Here, when the judgment result is Yes, the input destination and the transmission data are output to the protocol conversion processing unit (S104). Then, whether or not the output has been successful is judged (S105), and when the judgment result is Yes, the flow is terminated. On the other hand, when the judgment result of S103 is No, the input transmission data is output to an application corresponding to the input destination (S106). Then, whether or not the output has been successful is judged (S107), and when the judgment result is Yes, the flow is terminated.

Meanwhile, when S102, S105, or S107 is No, a corresponding error process is performed (S108), and the flow is terminated.

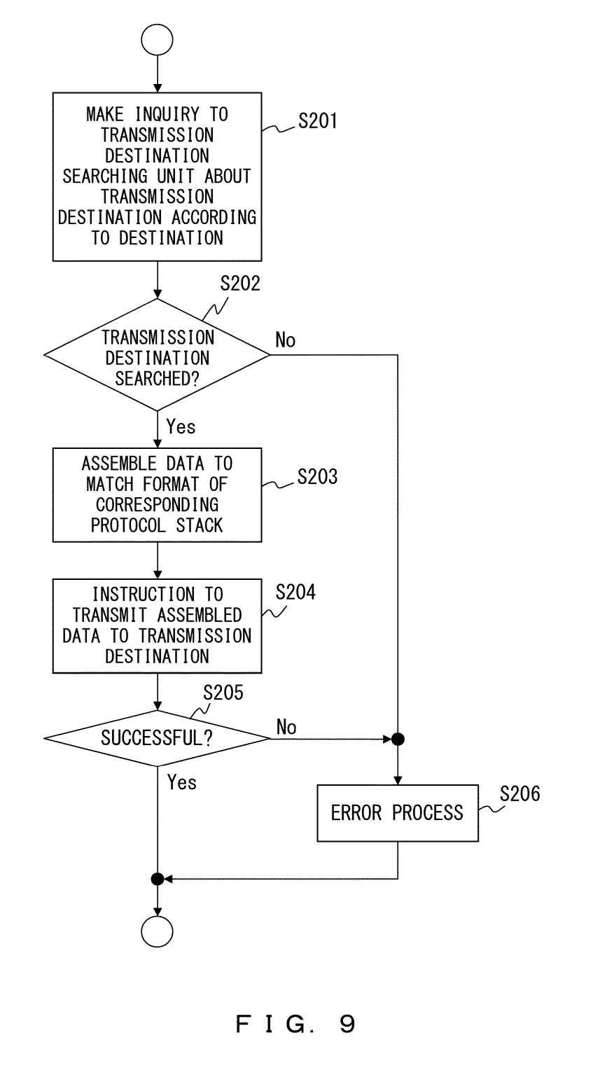

FIG. 9 is a flowchart illustrating an operation example of the respective protocol conversion processing units 134, 146, 149, 164. Meanwhile, the operations of the respective units are the same operation in corresponding apparatuses.

As illustrated in FIG. 9, when the destination and the transmission data are input from the process sorting unit, each protocol conversion processing unit performs the following process.

First, the input destination is output to the transmission destination searching unit, and an inquiry about the transmission destination according to the destination is made to the transmission destination searching unit (S201). Then, from the result of the inquiry, whether or not the transmission destination according to the destination has been searched is judged (S202). Here, when the judgment result is Yes, the input destination and the transmission data are assembled as data that matches the format of the corresponding protocol stack (S203). Next, an instruction is made to a corresponding I/O unit so as to transmit the data obtained by the process of S203 to the searched transmission destination (S204). Then, whether or not the instruction has been successful is judged (S205), and when the judgment result is Yes, the flow is terminated.

Meanwhile, when S202 or S205 is No, a corresponding error process is performed (S206), and the flow is terminated.

Meanwhile, while it is not illustrated in the drawing, when the data input from the corresponding I/O unit, as described above, each protocol conversion processing unit takes out the destination and the message data (data to pass to the application of the destination) from the input data, and output them to the process sorting unit.

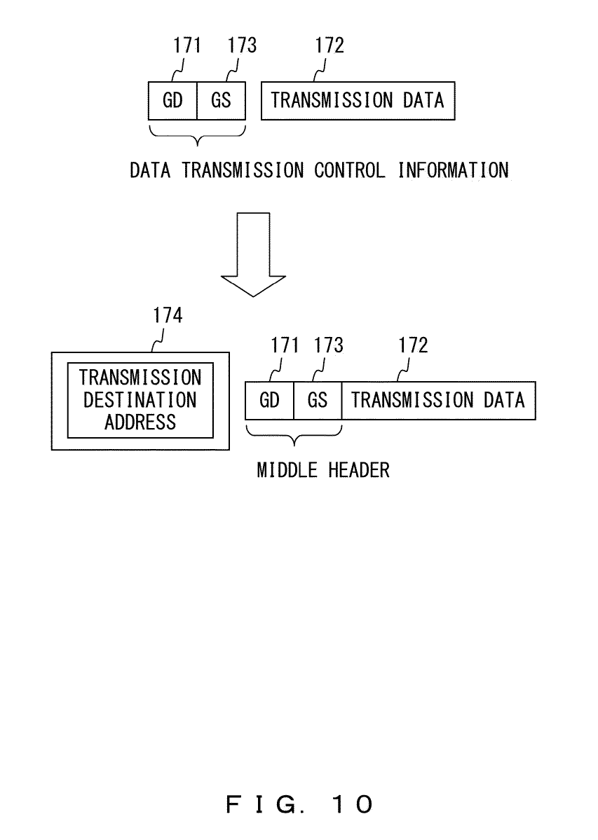

FIG. 10 illustrates a process example of S203 and S204.

In the example illustrated in FIG. 10, the destination and the transmission data input to the protocol conversion processing unit are represented as GD 171 and transmission data 172. Here, the GD 171 represents the ID of the apparatus and ID of the application to be the destination. Meanwhile, in this example, it is assumed that together with GD 171, GS 173 is also input to the protocol conversion processing unit. The GS 173 represents the ID of the transmission source node apparatus and the ID of the application. The GD 171 and GS 173 is data transmission control information.

In such a case, the protocol conversion processing unit generates a data part by combining the data transmission control information to the transmission data 172 as a header (middle header) that the network middleware refers to, thereby assembling them as data that matches the format of the protocol stack corresponding to the protocol conversion processing unit. Then, an instruction is made to a corresponding I/O unit so as to transmit the data to the searched transmission destination (transmission destination address 174).

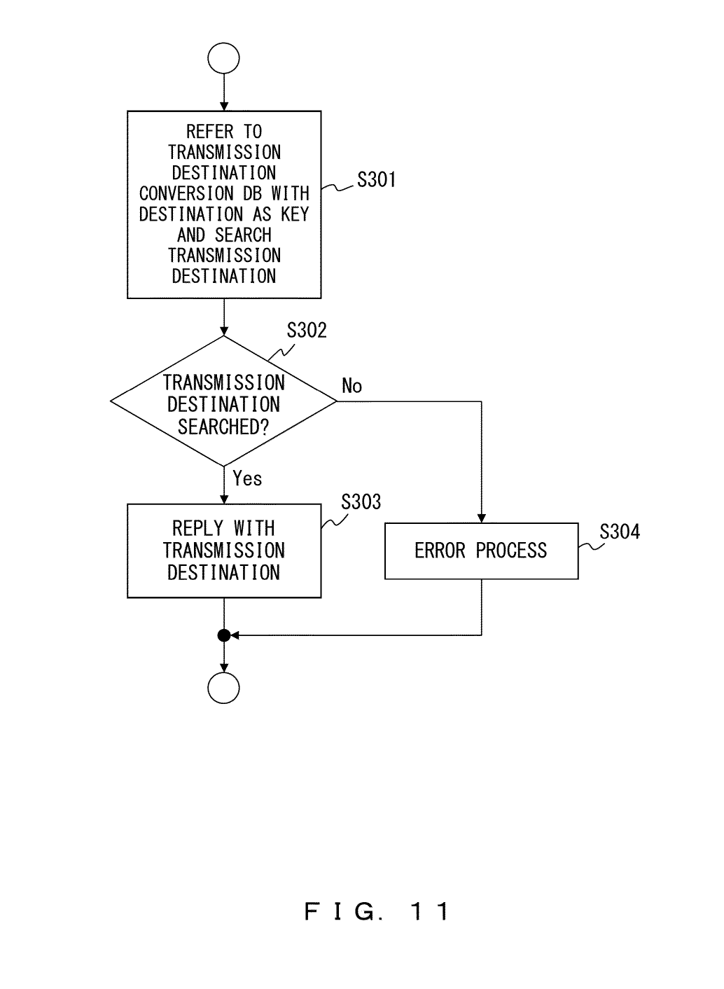

FIG. 11 is a flowchart illustrating an operation example of the respective transmission destination searching units 135, 144, 165. Meanwhile, the operations of the respective units are the same operation in corresponding apparatuses.

As illustrated in FIG. 11, when the destination is input from the protocol conversion processing unit and an inquiry about the transmission destination according to the destination is made, each transmission destination searching unit performs the following process.

First, the transmission destination conversion DB is referred to, and the transmission destination is searched with the input destination as the search key (S301), and whether or not the transmission destination corresponding to the destination has been searched is judged (S302). Here, when the judgment result is Yes, a reply is made to the protocol conversion processing unit of the inquiring source with the searched transmission destination (S303). On the other hand, when the judgment result of S302 is No, an error reply is made to the protocol conversion processing unit of the inquiring source (S304). Then, after S303 or S304, the flow is terminated.

Next, as an operation example of the system according to the present embodiment, the communication operation performed between the server apparatus 121_1, the gateway apparatus 124, the node apparatus 123_1 is explained, citing a specific example.

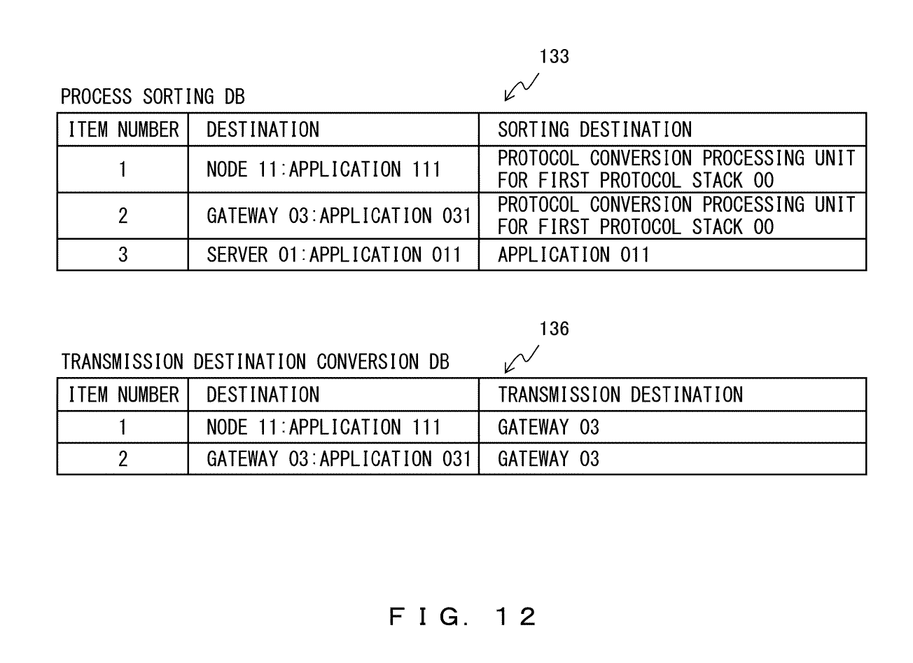

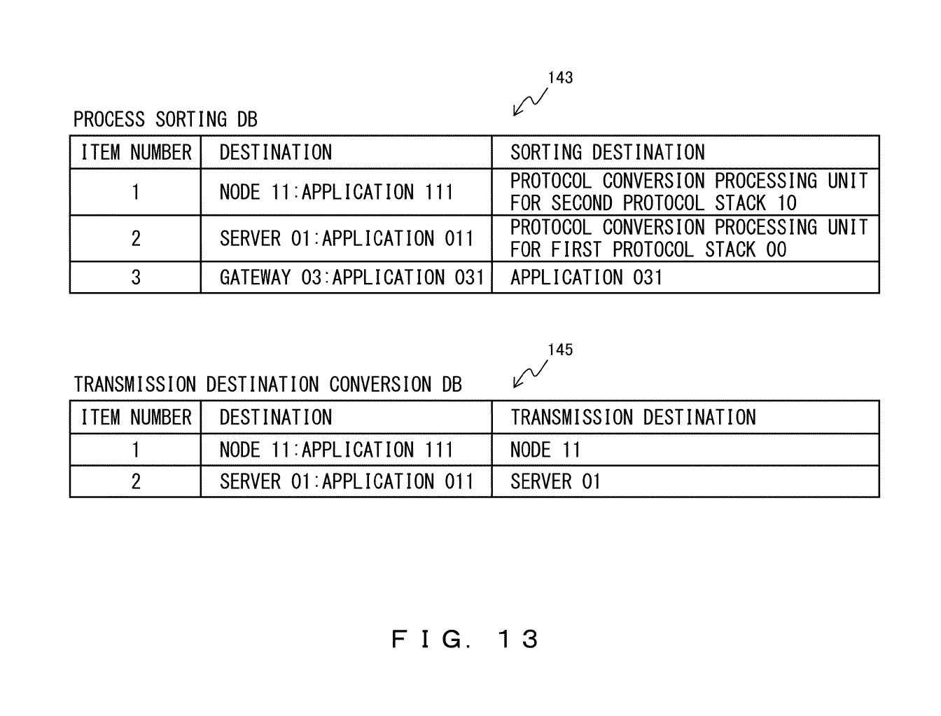

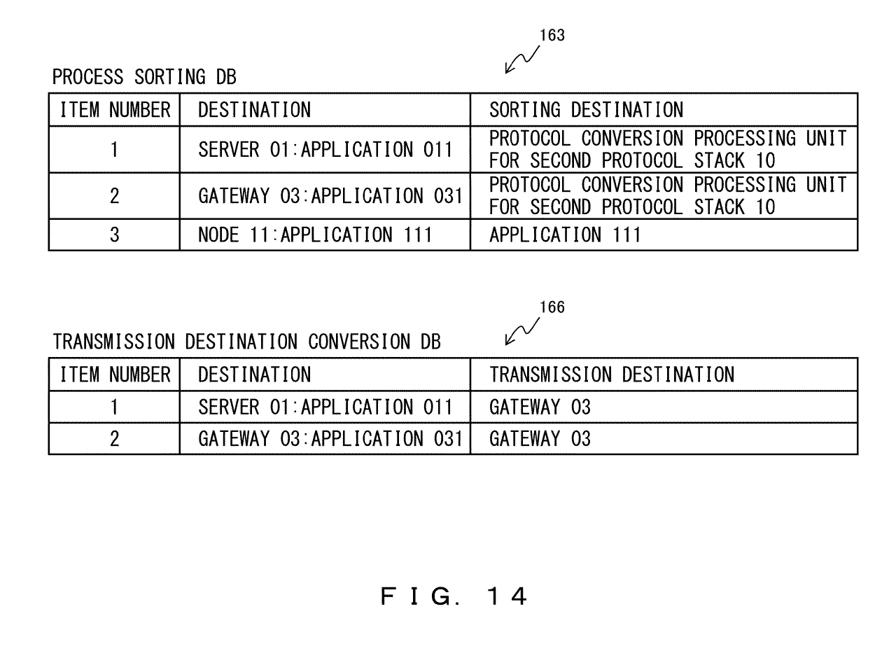

However, in the specific example cited here, it is assumed that, in the process sorting DB 133 and the transmission destination conversion DB 136 of the server apparatus 121_1, the information illustrated in FIG. 12 is stored. In addition, it is assumed that in the process sorting DB 143 and the transmission destination conversion DB 145 of the gateway apparatus 124, the information illustrated in FIG. 13 is stored. In addition, it is assumed that, in the process sorting DB 163 and the transmission destination conversion DB 166 of the node apparatus 123_1, the information illustrated in FIG. 14 is stored.

First, as specific example 1, the communication operation of the time when the application 125 of the server apparatus 121_1 transmits a message to the application 126 of the node apparatus 123_1 is explained. Meanwhile, the flow of the process of the communication operation is the flow illustrated in (1) through (8) in FIG. 4.

In the specific example 1, first, in the server apparatus 121_1, the process corresponding to (1) in FIG. 4 is performed. That is, the application 125 run in the arithmetic processing unit 131 outputs the ID:11 of the node apparatus 123_1 and the ID:111 of the application 126 to be the destination and message data to transmit, to the processing sorting unit 132.

Next, the process corresponding to (2) in FIG. 4 is performed. That is, the process sorting unit 132 refers to the process sorting DB 133, searches the sorting destination with the input destination as the search key, and outputs the input destination and message data to the searched sorting destination. Here, since the input destination is the ID:11 of the node apparatus 123_1 and the ID:111 of the application 126, the sorting destination is the protocol conversion processing unit 134 (protocol conversion processing unit for the first protocol stack 00) (see the item number 1 of the process sorting DB 133 in FIG. 12). Therefore, the process sorting unit 132 outputs the destination and the message data to the protocol conversion processing unit 134.

Next, the process corresponding to (3) in FIG. 4 is performed. That is, the protocol conversion processing unit 134 makes an inquiry to the transmission destination searching unit 135 about the transmission destination corresponding to the input destination. Here, since the input destination is the ID:11 of the node apparatus 123_1 and the ID:111 of the application 126, the transmission destination is the gateway apparatus 124 (gateway 03) (see the item number 1 of the transmission destination conversion DB 136 in FIG. 12). Then, the protocol conversion processing unit 134 assembles the input destination and message data as data that matches the format of the first protocol stack, and instructs the I/O unit 137 to transmit it to the gateway apparatus 124 being the destination. The I/O unit 137 performs a transmission process according to the first protocol stack according to the instruction, and transmits data from the communication unit 138 to the gateway apparatus 124.

Next, the process corresponding to (4) in FIG. 4 is performed. That is, in the gateway apparatus 124, when the first communication unit 148 receives data transmitted from the server apparatus 121_1, the first I/O unit 147 performs a reception process corresponding to the first protocol stack for the data, and outputs obtained data to the first protocol conversion processing unit 146. The first protocol conversion processing unit 146 takes out the destination and the message data, from the input data, and output them (the destination and the message data), to the process sorting unit 142.

Next, the process corresponding to (5) in FIG. 4 is performed. That is, the process sorting unit 142 refers to the process sorting DB 143, searches the sorting destination with the input destination as the search key, and outputs the input destination and message data to the searched sorting destination. Here, since the input destination is the ID:11 of the node apparatus 123_1 and the ID:111 of the application 126, the sorting destination is the second protocol conversion processing unit 149 (protocol conversion processing unit for the second protocol stack 10) (see the item number 1 of the process sorting DB 143 in FIG. 13). Therefore, the process sorting unit 142 outputs the destination and the message data to the second protocol conversion processing unit 149.

Next, the process corresponding (6) in FIG. 4 is performed. That is, the second protocol conversion processing unit 149 makes an inquiry, first, to the transmission destination searching unit 144 about the transmission destination according to the input destination. Here, since the input destination is the ID:11 of the node apparatus 123_1 and the ID:111 of the application 126, the transmission destination is the node apparatus 123_1 (node 11) (see the item number 1 of the transmission destination conversion DB 145 in FIG. 13). Then, the second protocol conversion processing unit 149 assembles the input destination and message data as data that matches the format of the second protocol stack, and instructs the second I/O unit 150 to transmit it to the node apparatus 123_1 being the destination. The second I/O unit 150 performs a transmission process according to the second protocol stack according to the instruction, and transmits data from the second communication unit 151 to the node apparatus 123_1.

Next, the process corresponding to (7) in FIG. 4 is performed. That is, in the node apparatus 123_1, when the communication unit 168 receives data transmitted from the gateway apparatus 124, the I/O unit 167 performs a reception process corresponding to the second protocol stack for the data, and outputs the obtained data to the protocol conversion processing unit 164. The protocol conversion processing unit 164 takes out the destination and the message data, from the input data, and outputs them, to the process storing unit 162.

Next, the process corresponding to (8) in FIG. 4 is performed. That is, the process sorting unit 162 refers to the process sorting DB 163, searches the sorting destination with the input destination as the search key, and outputs the input destination and message data to the searched sorting destination. Here, since the input destination is the ID:11 of the node apparatus 123_1 and the ID:111 of the application 126, the sorting destination is the application 126 (application 111) (see the item number 3 of the process sorting DB 163 in FIG. 14). Therefore, the process sorting unit 162 outputs the message data to the application 126 run on the arithmetic processing unit 161. Meanwhile, in this case, since the sorting destination and the destination correspond, only the message data is output to the sorting destination.

By the flow of the process as described above, the message is transmitted from the application 125 of the server apparatus 121_1 to the application 126 of the node apparatus 123_1.

Next, as specific example 2, in the opposite way to the communication operation of specific example 1, the communication operation of the time when the application 126 of the node apparatus 123_1 transmits a message to the application 125 of the server apparatus 121_1 is explained.

In the specific example 2, first, in the node apparatus 123_1, the application 126 run on the arithmetic processing unit 161 outputs, to the process sorting unit 162, ID:01 of the server apparatus 121_1 and ID:011 of the application 125 to be the destination, and the message data to transmit.

Next, the process sorting unit 162 refers to the process sorting DB 163, searches the sorting destination with the input destination as the search key, and outputs the input destination and message data to the searched sorting destination. Here, since the input destination is ID:01 of the server apparatus 121_1 and ID:011 of the application 125, the sorting destination is the protocol conversion processing unit 164 (protocol conversion processing unit for second protocol stack 10) (see the item number 1 of the process sorting DB 163 in FIG. 14). Therefore, the process sorting unit 162 outputs the destination and the message data to the protocol conversion processing unit 164.

Next, the protocol conversion processing unit 164 makes an inquiry, first, to the transmission destination searching unit 165 about the transmission destination according to the input destination. Here, since the input destination is ID:01 of the server apparatus 121_1 and ID:011 of the application 125, the transmission destination is the gateway apparatus 124 (gateway 03) (see the item number 1 of the transmission destination conversion DB 166 in FIG. 14). Then, the protocol conversion processing unit 164 assembles the input destination and message data as data that matches the format of the second protocol stack, and instructs the I/O unit 167 to transmit it to the gateway apparatus 124 being the transmission destination. The I/O unit 167 performs a transmission process according to the second protocol stack according to the instruction, and transmits the data from the communication unit 168 to the gateway apparatus 124.

Next, in the gateway apparatus 124, when the second communication unit 151 receives the data transmitted from the node apparatus 123_1, the second I/O unit 150 performs a reception process according to the second protocol stack for the data, and outputs the obtained data to the second protocol conversion processing unit 149. The second protocol conversion processing unit 149 takes out the destination and message data, from the input data, and outputs them, to the process sorting unit 142.

Next, the process sorting unit 142 refers to the process sorting DB 143, searches the sorting destination with the input destination as the search key, and outputs the input destination and message data to the searched sorting destination. Here, since the input destination is ID:01 of the server apparatus 121_1 and ID:011 of the application 125, the sorting destination is the first protocol conversion processing unit 146 (protocol conversion processing unit for the first protocol stack 00) (see the item number 2 of the process sorting DB 143 in FIG. 13). Therefore, the process sorting unit 142 outputs the destination and the message data to the first protocol conversion processing unit 146.

Next, the first protocol conversion processing unit 146 makes an inquiry, first, to the transmission destination searching unit 144 about the transmission destination according to the input destination. Here, since the input destination is ID:01 of the server apparatus 121_1 and ID:011 of the application 125, the transmission destination is the server apparatus 121_1 (server 01) (see the item number 2 of the transmission destination conversion DB 145 in FIG. 13). Then, the first protocol conversion processing unit 146 assembles the input destination and message data as data that matches the format of the first protocol stack, and instructs the first I/O unit 147 to transmit it to the server apparatus 121_1 being the destination. The first I/O unit 147 performs a transmission process according to the first protocol stack according to the instruction, and transmits the data from the first communication unit 148 to the server apparatus 121_1.

Next, in the server apparatus 121_1, when the communication unit 138 receives the data transmitted from the gateway apparatus 124, the I/O unit 137 performs a reception process according to the first protocol stack for the data, and outputs the obtained data to the protocol conversion processing unit 134. The protocol conversion processing unit 134 takes out the input destination and message data, from the input data, and outputs them, to the process sorting unit 132.

Next, the process sorting unit 132 refers to the process sorting DB 133, searches the sorting destination with the input destination as the search key, and outputs the input destination and message data to the searched sorting destination. Here, since the input destination is ID:01 of the server apparatus 121_1 and ID:011 of the application 125, the sorting destination is the application 125 (application 011) (See item number 3 of the process sorting DB 133 in FIG. 12). Therefore, the process sorting unit 132 outputs the message data to the application 125 run on the arithmetic processing unit 131. Meanwhile, in this case, since the sorting destination and the destination correspond, only the message data is output to the sorting destination.

By the flow of the process as described above, a message is transmitted from the application 126 of the node apparatus 123_1 to the application 125 of the server apparatus 121_1.

Next, as specific example 3, the communication operation of the time when the application 125 of the server apparatus 121_1 transmits a message to the application 128 of the gateway apparatus 124 (see FIG. 4) is explained.

In the specific example 3, first, in the server apparatus 121_1, the application 125 run on the arithmetic processing unit 131 outputs ID:03 of the gateway apparatus 124 and ID:031 of the application 126 to be the destination and the message data to transmit, to the process sorting unit 132.

Next, the process sorting unit 132 refers to the process sorting DB 133, searches the sorting destination with the input destination as the search key, and outputs the input destination and message data to the searched sorting destination. Here, since the input destination is ID:03 of the gateway apparatus 124 and ID:031 of the application 126, the sorting destination is the protocol conversion processing unit 134 (protocol conversion processing unit for the first protocol stack 00) (see the item number 2 of the process sorting DB 133 in FIG. 12). Therefore, the process sorting unit 132 outputs the destination and message data to the protocol conversion processing unit 134.

Next, the protocol conversion processing unit 134 makes an inquiry, first, to the transmission destination searching unit 135, about the transmission destination according to the input destination. Here, since the input destination is ID:03 of the gateway apparatus 124 and ID:031 of the application 126, the transmission destination is the gateway apparatus 124 (gateway 03) (see the item number 2 of the transmission destination conversion DB 136 in FIG. 12). Then, the protocol conversion processing unit 134 assembles the input destination and message data as data that matches the format of the first protocol stack and instructs the I/O unit 137 to transmit it to the gateway apparatus 124 being the transmission destination. The I/O unit 137 performs a transmission process according to the first protocol stack according to the instruction, and transmits data from the communication unit 138 to the gateway apparatus 124.

Next, in the gateway apparatus 124, when the first communication unit 148 receives the data transmitted from the server apparatus 121_1, the first I/O unit 147 performs a reception process according to the first protocol stack for the data, and outputs the obtained data to the first protocol conversion processing unit 146. The first protocol conversion processing unit 146 takes out the destination and message data, from the input data, and outputs them, to the process sorting unit 142.

Next, the process sorting unit 142 refers to the process sorting DB 143, searches the sorting destination with the input destination as the search key, and outputs the input destination and message data to the searched sorting destination. Here, since the input destination is ID:03 of the gateway apparatus 124 and ID:031 of the application 126, the sorting destination is the application 128 (application 031) (see the item number 3 of the process sorting DB 143 in FIG. 13). Therefore, the process sorting unit 142 outputs the message data to the application 128 run on the arithmetic processing unit 151. Meanwhile, in this case, since the sorting destination and the destination correspond, only the message data is output to the sorting destination.

By the flow of the process as described above, a message is transmitted from the application 125 of the server apparatus 121_1 to the application 128 of the gateway apparatus 124.

Next, as specific example 4, in the opposite way to the communication operation in the specific example 3, the communication operation of the time when the application 128 of the gateway apparatus 124 transmits a message to the application 125 of the server apparatus 121_1 is explained.

In the specific example 4, first, in the gateway apparatus 124, the application 128 run on the arithmetic processing unit 151 outputs ID:01 of the server apparatus 121_1 and ID:011 of the application 125 to be the destination and the message data to transmit, to the process sorting unit 142.

Next, the process sorting unit 142 refers to the process sorting DB 143, searches the sorting destination with the input destination as the search key, and outputs the input destination and message data to the searched sorting destination. Here, since the input destination is the ID:01 of the server apparatus 121_1 and ID:011 of the application 125, the sorting destination is the first protocol conversion processing unit 146 (protocol conversion processing unit for the first protocol stack 00) (see the item number 2 of the process sorting DB 143 in FIG. 13). Therefore, the process sorting unit 142, outputs the destination and message data to the first protocol conversion processing unit 146.

The subsequent process is the same as the process after the process sorting unit 142 of the gateway apparatus 124 outputs the destination and message data to the first protocol conversion processing unit 146 in the specific example 2 described above, and its explanation is omitted here.

By the flow of the process as described above, a message is transmitted from the application 128 of the gateway apparatus 124 to the application 125 of the server apparatus 121_1.

Next, as specific example 5, the communication operation of the time when the application 126 of the node apparatus 123_1 transmits a message to the application 128 of the gateway apparatus 124 is explained.

In the specific example 5, first, in the node apparatus 123_1, the application 126 run on the arithmetic processing unit 171 outputs ID:03 of the gateway apparatus 124 and ID:031 of the application 128 to be the destination and the message data to transmit, to the process sorting unit 162.

Next, the process sorting unit 162 refers to the process sorting DB 163, searches the sorting destination with the input destination as the search key, and outputs the input destination and message data to the searched sorting destination. Here, since the input destination is the ID:03 of the gateway apparatus 124 and ID:031 of the application 128, the sorting destination is the protocol conversion processing unit 164 (protocol conversion processing unit for the second protocol stack 10) (see the item number 2 of the process sorting DB 163 in FIG. 14). Therefore, the process sorting unit 162 outputs the destination and message data to the protocol conversion processing unit 164.

Next, the protocol conversion processing unit 164 makes an inquiry, first, to the transmission destination searching unit 165 about the transmission destination according to the input destination. Here, since the input destination is the ID:03 of the gateway apparatus 124 and ID:031 of the application 128, the transmission destination is the gateway apparatus 124 (gateway 03) (see the item number 2 of the transmission destination conversion DB 166 in FIG. 14). Then, the protocol conversion processing unit 164 assembles the input destination and message data as data that matches the second protocol stack, and instructs the I/O unit 167 to transmit it to the gateway apparatus 124 being the transmission destination. The I/O unit 167 performs a transmission process according to the second protocol stack according to the instruction, and sends the data from the communication unit 168 to the gateway apparatus 124.

Next, in the gateway apparatus 124, when the second communication unit 151 receives the data transmitted from the node apparatus 123_1, the second I/O unit 150 performs a reception process according to the second protocol stack for the data, and outputs the obtained data to the second protocol conversion processing unit 149. The second protocol conversion processing unit 149 takes out the destination and message data, from the input data, and outputs them, to the process sorting unit 142.

Next, the process sorting unit 142 refers to the process sorting DB 143, searches the sorting destination with the input destination as the search key, and outputs the input destination and message data to the searched sorting destination. Here, since the input destination is ID:03 of the gateway apparatus 124 and ID:031 of the application 128, the sorting destination is the application 128 (application 031) (see the item number 3 of the process sorting DB 143 in FIG. 13). Therefore, the process sorting unit 142 outputs the message data to the application 128 run on the arithmetic processing unit 151. Meanwhile, in this case, since the sorting destination and the destination correspond, only the message data is output to the sorting destination.

By the flow of the process as described above, a message is transmitted from the application 126 of the node apparatus 123_1 to the application 128 of the gateway apparatus 124.

Next, as specific example 6, in the opposite way to the communication operation in specific example 5, the communication operation of the time when the application 128 of the gateway apparatus 124 transmits a message to the application 126 of the node apparatus 123_1 is explained.

In the specific example 6, first, in the gateway apparatus 124, the application 128 run on the arithmetic processing unit 151 outputs ID:11 of the node apparatus 123_1 and ID:111 of the application 126 to be the destination and the message data to the process sorting unit 142.

Next, the process sorting unit 142 refers to the process sorting DB 143, searches the sorting destination with the input destination as the search key, and outputs the input destination and message data to the searched sorting destination Here, since the input destination is ID:11 of the node apparatus 123_1 and ID:111 of the application 126, the sorting destination is the second protocol conversion processing unit 149 (protocol conversion processing unit of the second protocol stack 10) (see the item number 1 of the process sorting DB 143 in FIG. 13). Therefore, the process sorting unit 142 outputs the destination and message data to the second protocol conversion processing unit 149.

The subsequent process is the same as the process after the process sorting unit 142 of the gateway apparatus 124 outputs the destination and message data to the second protocol conversion processing unit 149 in the specific example 1 described above, and its explanation is omitted here.

By the flow of the process as described above, a message is transmitted from the application 128 of the gateway apparatus 124 to the application 126 of the node apparatus 123_1.

Meanwhile, it is also possible to perform a communication operation in which a plurality of specific examples described above are combined.

For example, it is also possible to perform a communication operation in which the specific example 3 and the specific example 6 are combined. In this case, a communication operation is possible in which, after the application 125 of the server apparatus 121_1 transmits a message to the application 128 of the gateway apparatus 124, the application 128 of the gateway apparatus 124 transmits a message to the application 126 of the node apparatus 123_1. In such as case, for example, a communication operation in which, the application 128 of the gateway apparatus 124 transmits data received from the application 125 of the server apparatus 121_1 to all of the respective node apparatuses under the gateway apparatus 124, is possible.

Meanwhile, for example, it is also possible to perform a communication operation in which the specific example 4 and the specific example 5 are combined. IN this case, a communication operation in which, after the application 126 of the node apparatus 123_1 transmits a message to the application 128 of the gateway apparatus 124, the application 128 of the gateway apparatus 124 transmits a message to the application 125 of the server apparatus 121_1, is possible. In such a case, for example, it a communication operation in which, after the application 128 of the gateway apparatus 124 processes data (for example, sensor data output from the application 125) received from the respective node apparatuses during a prescribed period of time, the data of the processing result is transmitted to the application 125 of the server apparatus 121_1, is possible.

As described above, in the system according to the present embodiment, the each apparatus of the respective server apparatuses 121, the gateway apparatus 124, and the respective node apparatuses 123 is equipped with the network middleware, and therefore, the communication protocols of the respective networks are abstracted, realizing a virtual network (see FIG. 3). Therefore, the each apparatus of the respective server apparatuses 121, the gateway apparatus 124, and the respective node apparatuses 123 is able to perform communication with other apparatus in a unified method without distinction between the respective server apparatuses 121, the gateway apparatus 124, the respective node apparatuses 123, without consideration of the actual communication protocols.

Next, as another operation example of the system according to the present embodiment, an operation in a case in which an apparatus (a server apparatus, a gateway apparatus, a node apparatus) is newly added to the system is explained. Meanwhile, the apparatus that is added newly has the same configuration as the configuration illustrated in FIG. 5 through FIG. 7, for example.

Here, as a representative, an example of a case when a node apparatus is newly added is explained, but a similar operation is performed as well in a case when a server apparatus and a gateway apparatus is newly added.

In addition, here, it is assumed that the server apparatus (management server apparatus) which manage the newly added apparatus is the server apparatus 121_1. In addition, it is assumed that, in the process sorting DB and the transmission destination conversion DB of the apparatus that is to be newly added and the respective apparatuses that are already provided, information for the destination being a management application (application for management) of the management server apparatus 121_1 is included. That is, in each process sorting DB, information of the sorting destination for the destination being the management application of the management server apparatus 121_1 is included, and in each transmission destination conversion DB, information of the transmission destination for the destination being the management application of the management server apparatus 121_1. In addition, it is assumed that the apparatus that is to be newly added and the respective apparatuses that are already provided include an application that updates the process sorting DB and the transmission destination conversion DB (application for update), as an application run by the arithmetic processing unit. In addition, it is assumed that that the apparatus that is to be newly added includes an addition process application (application for addition) for performing a node addition notification to the management server apparatus 121_1, as an application run by the arithmetic processing unit.

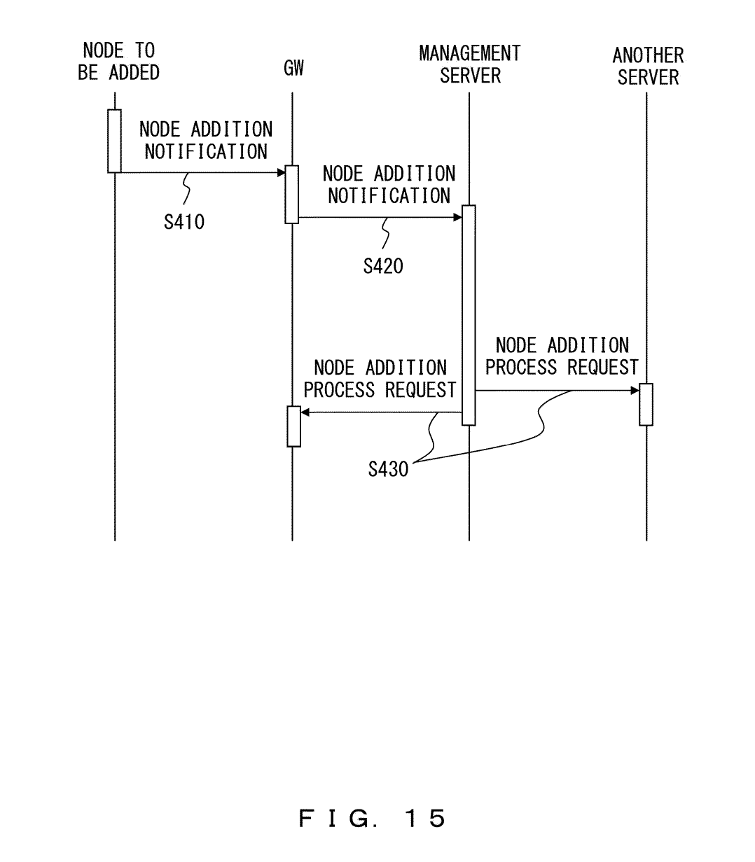

FIG. 15 illustrates an example of a process sequence of the overall system in a case in which a node apparatus is newly added. In the sensor network, a large number of node apparatuses equipped with a sensor may be newly added or removed. At this time, in order to add a node apparatus to the management server apparatus 121_1 without setting, the node apparatus that is to be newly added sends a notification of own information to the management server apparatus 121_1. At this time, there is no need to set, in the node apparatus that is to be newly added, information (an IP address for example) specific to the network that uniquely identifies the management server apparatus 121_1

As illustrated in FIG. 15, when the node apparatus that is to be newly added is connected to the network 122_2, a node addition notification is performed from the node apparatus to the management server apparatus 121_1 via the gateway apparatus 124 (S410, S420). When the management server apparatus 121_1 receives the node addition notification, a node addition process request is performed from the management server apparatus 121_1 to the gateway apparatus 124 and another server apparatus 121_2 (S430).

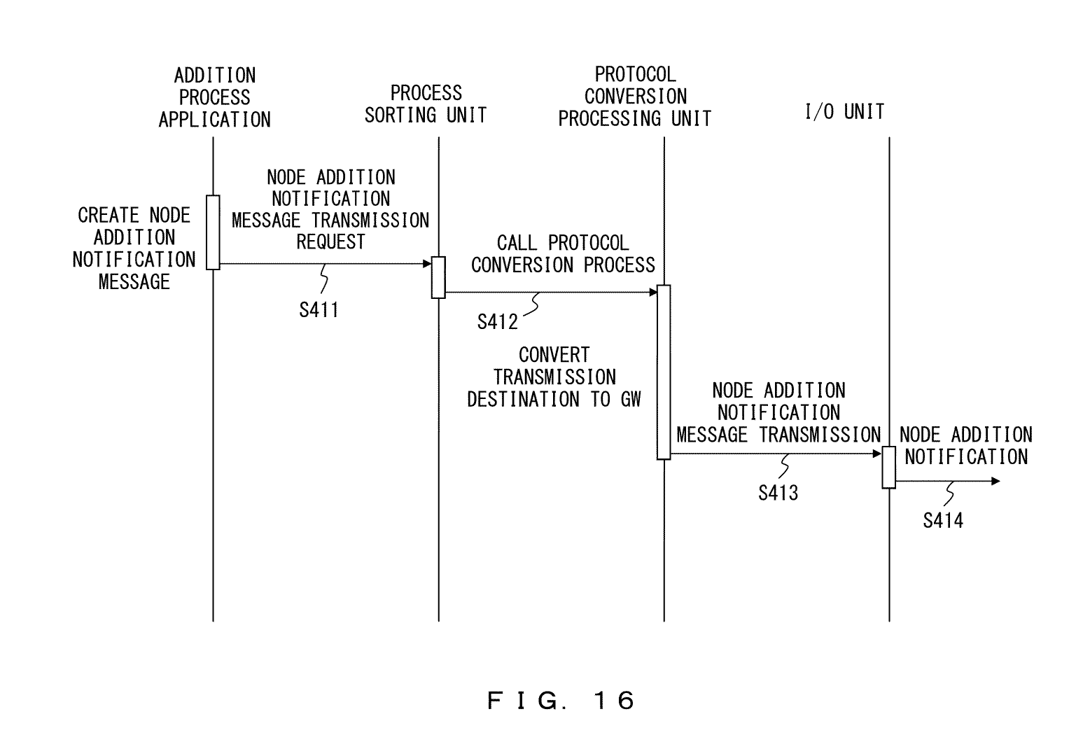

The process sequence of each apparatus in such a process sequence is illustrated in FIG. 16 through FIG. 19.

FIG. 16 is a diagram illustrating an example of a process sequence of the newly-added node apparatus.

As illustrated in FIG. 16, when the node apparatus that is to be newly added is connected to the network 122_2, in the node apparatus, the following process is performed.

First, the addition process application run by the arithmetic processing unit 161 performs a process to create a node addition notification message, and to make a request to the process sorting unit 162 to transmit it (S411). Specifically, the addition process application outputs the ID of the management server apparatus 121_1 and the ID of the management application of the apparatus 121_1 as the destination, and node addition notification message data as message data, to the process sorting unit 162.

Next, the process sorting unit 162 refers to the process sorting DB 163, and performs a process to call a protocol conversion process (S412). Specifically, the process sorting unit 162 refers to the process sorting DB 163, searches the sorting destination with the input destination as the search key, and outputs the input destination and message data to the searched sorting destination. Here, in the process sorting DB 163, information that the protocol conversion processing unit 164 is the sorting destination for the destination being the management application of the management server apparatus 121_1 is included. Therefore, the process sorting unit 162 outputs the destination and message data to the protocol conversion processing unit 164.

Next, the protocol conversion processing unit 164 performs the process of node addition notification message transmission, with the gateway apparatus 124 being the transmission destination (S413). Specifically, the protocol conversion processing unit 164 makes, first, an inquiry to transmission destination searching unit 165 about the transmission destination according to the input destination. Here, in the transmission destination conversion DB 166, information that the gateway apparatus 124 is the transmission destination for the destination being the management application of the management server apparatus 121_1. Therefore, the transmission destination searching unit 165 makes a reply that the transmission destination is the gateway apparatus 124. Then, the protocol conversion processing unit 164 assembles the input destination and message data as data that matches the second protocol stack, and instructs the I/O unit 167 to send it to the gateway apparatus 124 being the transmission destination.

Next, the I/O unit 167 performs a process of node addition notification (S414). Specifically, the I/O unit 167 performs a transmission process according to the second protocol stack, according to the instruction from the protocol conversion processing unit 164, and transmits data from the communication unit 168 to the gateway apparatus 124.

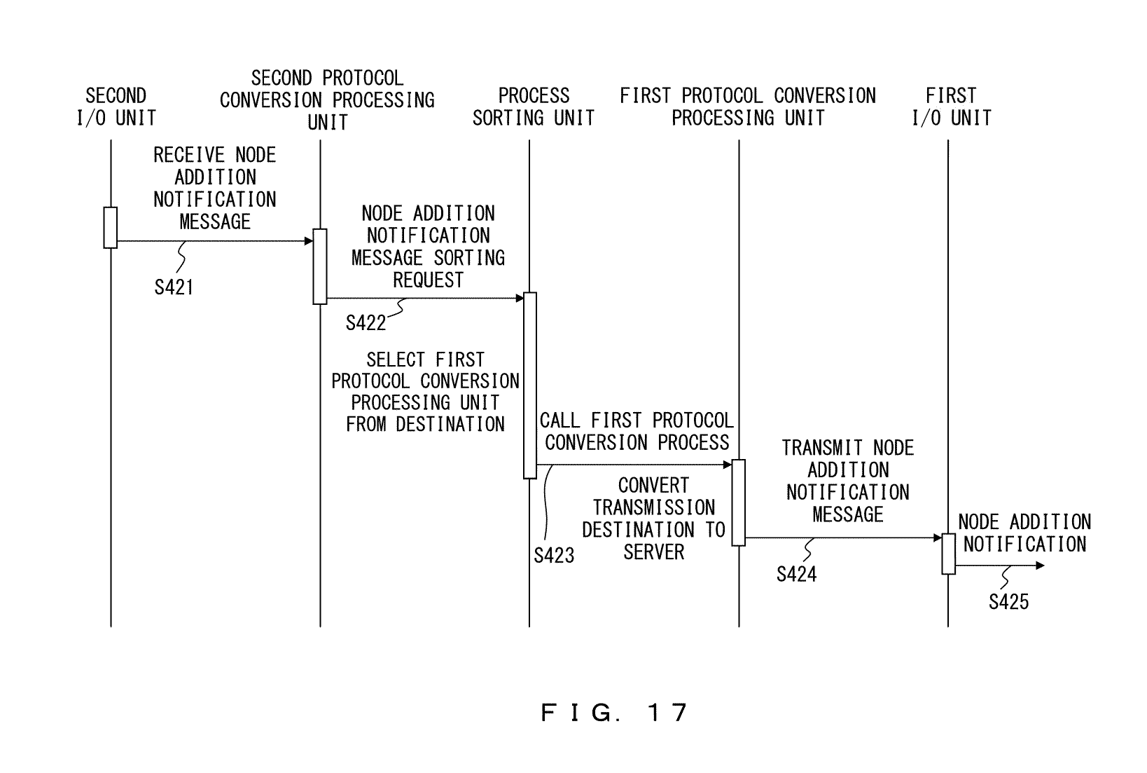

FIG. 17 illustrates an example of the process sequence of the gateway apparatus 124.

As illustrated in FIG. 17, when the gateway apparatus 124 receives data transmitted from the newly-added node apparatus, the following process is performed in the gateway apparatus 124.

First, when the second communication unit 151 receives data transmitted from the newly-added apparatus, the second I/O unit 150 performs a process to receive a node addition notification message (S421). Specifically, the second I/O unit 150 performs a reception process according to the second protocol stack for the data, and outputs the obtained data to the second protocol conversion processing unit 149.

Next, the second protocol conversion processing unit 149 performs a process to make a request to the process sorting unit 142 for the sorting of the node addition notification message (S422). Specifically, the second protocol conversion processing unit 149 takes out the destination and message data, from the input data, and outputs them, to the process sorting unit 142.

Next, the process sorting unit 142 refers to the process sorting DB 143, and performs a process to call a first protocol conversion process (S423). Specifically, process sorting unit 142 refers to the process sorting DB 143, searches the sorting destination with the input destination as the search key, and outputs the input destination and message data to the searched sorting destination. Here, in the process sorting DB 143, information that the first protocol conversion processing unit 146 is the sorting destination of the destination being the management application of the management server apparatus 121_1 is included. Therefore, the process sorting unit 142 outputs the destination and message data to the first protocol conversion processing unit 146.

Next, the first protocol conversion processing unit 146 performs a process of node addition notification message transmission, with the management server apparatus 121_1 being the destination (S424). Specifically, first protocol conversion processing unit 146 makes an inquiry, first, to the transmission destination searching unit 144 about the transmission destination according to the input destination. Here, in the transmission destination conversion DB 145, information that the management server apparatus 121_1 is the transmission destination for the destination being the management application of the management server apparatus 121_1. Therefore, the transmission destination searching unit 144 makes a reply that the transmission destination is the management server apparatus 121_1. Then, the first protocol conversion processing unit 146 assembles the input destination and message data as data that matches the first protocol stack, and instructs the first I/O unit 147 to transmit it to the management server apparatus 121_1 being the transmission destination.

Next, the first I/O unit 147 performs a process of node addition notification (S425). Specifically, the first I/O unit 147 performs a transmission process according to the first protocol stack, according to the instruction from the first protocol conversion processing unit 146, to transmit data from the first communication unit 148 to the management server apparatus 121_1.

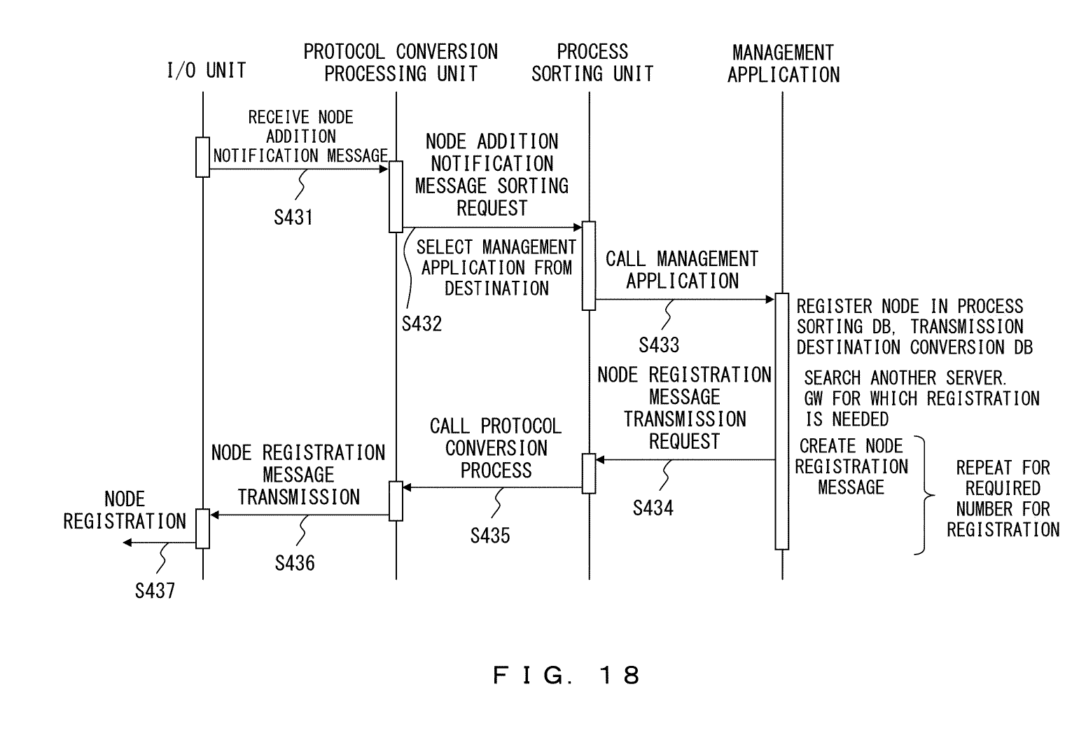

FIG. 18 illustrates an example of the process sequence of the management server apparatus 121_1.

As illustrated in FIG. 18, when the management server apparatus 121_1 receives data transmitted from the gateway apparatus 124, the following process is performed in the management server apparatus 121_1.

First, when the communication unit 138 receives data transmitted from the gateway apparatus 124, the I/O unit 137 performs a process to receive the node addition notification message. Specifically, the I/O unit 137 performs the reception process according to the first protocol stack for the data, and outputs the obtained data to the protocol conversion processing unit 134.

Next, the protocol conversion processing unit 134 performs a process to makes a request to the process sorting unit 132 for the sorting of the node addition notification message (S432). Specifically, protocol conversion processing unit 134 takes out the destination and message data, from the input data, and outputs them, to the process sorting unit 132.

Next, the process sorting unit 132 refers to the process sorting DB 133, and performs a process to call the management application (S433). Specifically, process sorting unit 132 refers to the process sorting DB 133, searches the sorting destination with the input destination as the search key, and outputs the input destination and message data to the searched sorting destination. Here, in the process sorting DB 133, information that the management application is the sorting destination for the destination being the management application of the management server apparatus 121_1 is included. Therefore, the process sorting unit 132 outputs the destination and message data to the management application run on the arithmetic processing unit 131. Meanwhile, in this case, since the sorting destination and the destination correspond, only the message data is output to the sorting destination.

Next, the management application performs a process to register information regarding the added node apparatus, based on the input message data, in the process sorting DB 133 and the transmission destination conversion DB 136, and also to create a node registration message, and to make a request to the process sorting unit 132 to transmit it (S434). Specifically, when the message data is input from the process sorting unit 132, the management application recognized that a node apparatus has been newly added. Then, according to the input message data, information of the sorting destination being the protocol conversion processing unit 134 for the destination being the application of the added node apparatus is registered in the process sorting DB 133. In addition, information of the transmission destination being the gateway apparatus 124 for the destination being the application of the added node apparatus is registered in the transmission destination conversion DB 136. Next, the management application searches for another server apparatus and gateway apparatus 124 in which registration of the information regarding the added node apparatus is needed. Then, a node registration message to transmit to the searched apparatus is created, and the ID of the searched apparatus and the ID of the update application of the apparatus as the destination, and the node registration message data as the message data, are output to the process sorting unit 132. Meanwhile, in this S434, when a plurality of apparatuses for which in which registration of the information regarding the added node apparatus is needed have been searched, the process from the creation of the node registration message to the S437 is performed for each of the searched apparatuses.

Next, the process sorting unit 132 refers to the process sorting DB 133, and performs a process to call a protocol conversion process (S435). Specifically, process sorting unit 132 refers to the process sorting DB 133, searches the sorting destination with the input destination as the search key, and outputs the input destination and message data to the searched sorting destination. Here, the process sorting unit 132 outputs the destination and message data to the protocol conversion processing unit 134.

Next, the protocol conversion processing unit 134 performs a process of node registration message transmission (S436). Specifically, protocol conversion processing unit 134 makes an inquiry to the transmission destination searching unit 135 about the transmission destination according to the input destination. Then, the protocol conversion processing unit 134 assembles the input destination and message data as data that matches the second protocol stack, and instructs the I/O unit 137 to transmit it to transmission destination inquired.

Next, the I/O unit 137 performs a process of node registration (S437). Specifically, the I/O unit 137 performs a transmission process according to the first protocol stack, according to the instruction from the protocol conversion processing unit 134, to transmit data from the communication unit 138 to the transmission destination.

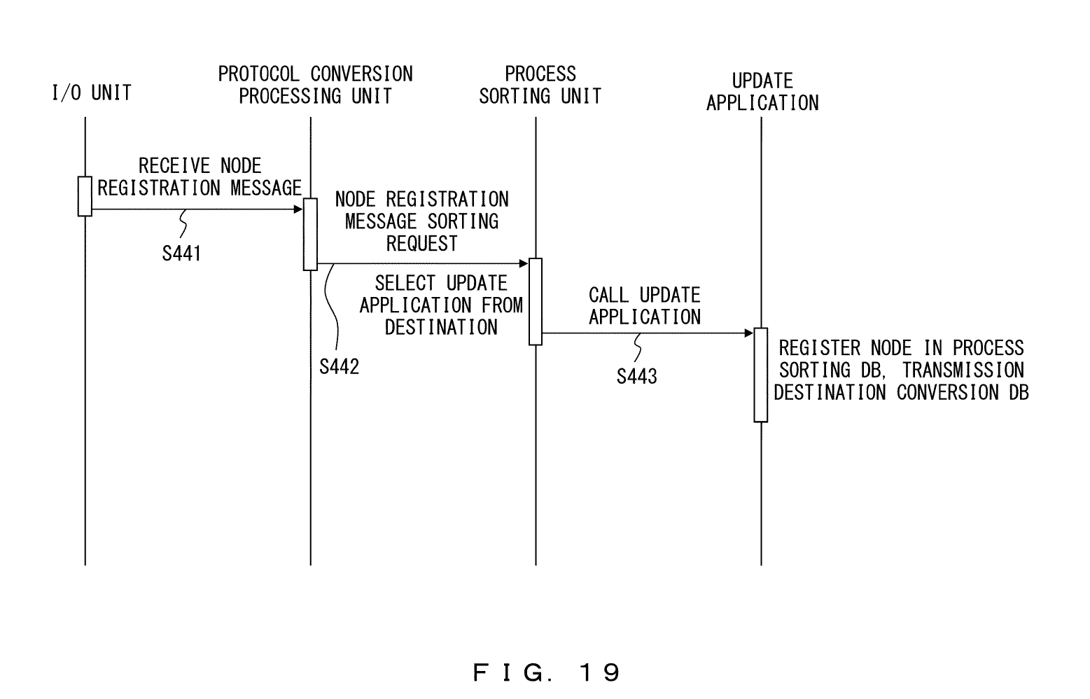

FIG. 19 is a diagram illustrating an example of a process sequence of an apparatus being the transmission destination of data transmitted from the management server apparatus 121_1. Meanwhile, the apparatus is also an apparatus in which registration of information regarding the newly-added node apparatus is needed (the server apparatus 121_2, the gateway apparatus 124). Here, the explanation is made assuming the apparatus as the server apparatus 121_2.

As illustrated in FIG. 19, when the server apparatus 121_2 receives data transmitted from the management server apparatus 121_1, the following process is performed in the server apparatus 121_2.

First, when the communication unit 138 receives data transmitted from the management server apparatus 121_1, the I/O unit 137 performs a process to receive the node registration message (S441). Specifically, the I/O unit 137 performs a reception process according to the first protocol stack for the data, and outputs the obtained data to the protocol conversion processing unit 134.

Next, the protocol conversion processing unit 134 performs a process to make a request to the process sorting unit 132 for the sorting of the node registration message (S442). Specifically, the protocol conversion processing unit 134 takes out the destination and message data, from the input data, and outputs them, to the process sorting unit 132.

Next, the process sorting unit 132 refers to the process sorting DB 133, and performs a process to call the update application (S443). Specifically, the process sorting unit 132 refers to the process sorting DB 133, searches the sorting destination with the input destination as the search key, and outputs the input destination and message data to the searched sorting destination. Here, in the process sorting DB 133, information that the update application is the sorting destination for the update application of the server apparatus 121_2 being the destination is included. Therefore, the process sorting unit 132 outputs the destination and message data to the update application run on the arithmetic processing unit 131. Meanwhile, in this case, since the sorting destination and the destination correspond, only the message data is output to the sorting destination.

Next, the update application performs a process to register information regarding the newly-added node apparatus, based on the input message data, in the process sorting DB 133 and the transmission destination conversion DB 136 (S444). Specifically, based on the input message data, the update application registers, in the process sorting DB 133, information of the protocol conversion processing unit 134 being the sorting destination for the application of the added node apparatus being the destination. Meanwhile, in the transmission destination conversion DB 136, information of the gateway apparatus 124 being the transmission destination for the application of the added node apparatus being the destination is registered.

By the flow of the process as described above, when a node apparatus is newly added, node addition notification is performed from the node apparatus to the management server apparatus 121_1, and from the management server apparatus 121_1 that received it, node registration is performed for necessary apparatuses (the gateway apparatus 124 and another server apparatus 121_2).

Meanwhile, here, when an apparatus is newly added, a process is performed as described above, but for example, it is also possible that the newly added apparatus sends notification to surrounding apparatuses by broadcast, to transmit in a propagating manner.

In addition, while an example of a case in which an apparatus is newly added is illustrated here, the process may be performed in a similar way in a case of moving an apparatus that has already been provided.

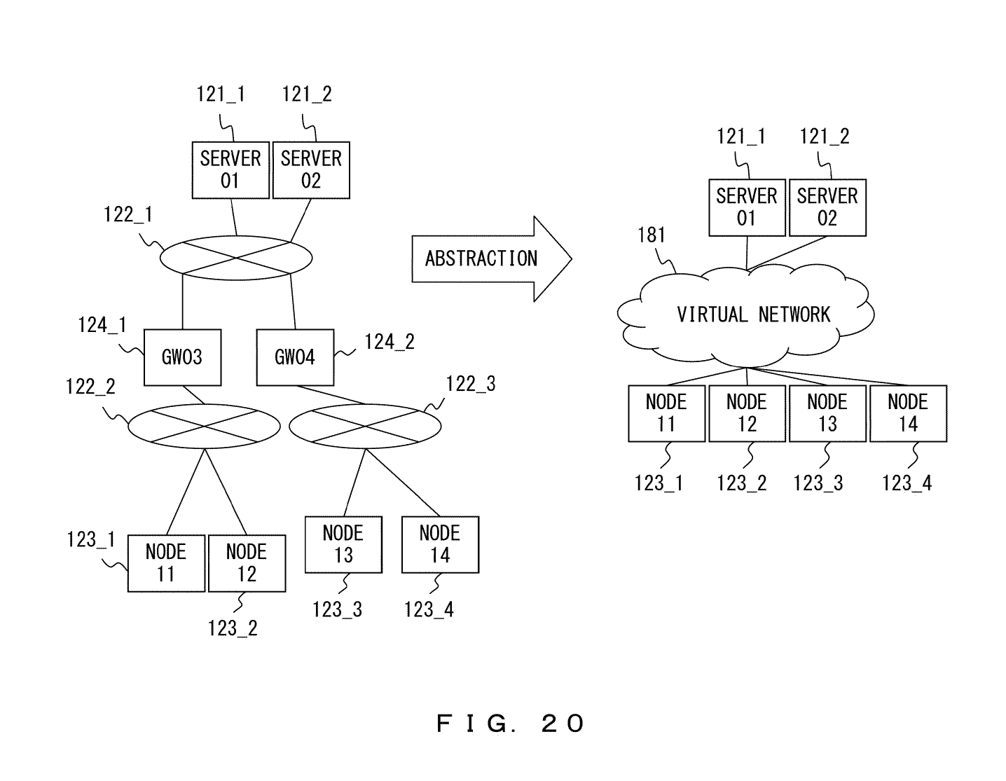

While the system according to the present embodiment has been explained above, the system is not limited to the configuration illustrated in FIG. 3, and may also be in another configuration as illustrated in FIG. 20 through FIG. 22 for example.

FIG. 20 is a first diagram illustrating another configuration example of the system according to the present embodiment.

The system of the configuration example illustrated in FIG. 20 is in an configuration equipped with a plurality of gateway apparatuses. In this system, a network 122_1 including two server apparatuses 121_1, 121_2 and a network 122_2 including two node apparatuses 123_1, 123_2 are connected via the gateway apparatus 124_1. In addition, the 122_1 and a network 122_3 including two node apparatuses 123_3, 123_4 are connected via a gateway apparatus 124_2. Here, in the network 122_3, in the same manner as the network 122_2, the communication protocol of the second protocol stack is used. The node apparatus 123_4 has the same configuration as the other three node apparatuses 123_1, 123_2, 123_3, and in addition, the gateway apparatus 124_2 has the same configuration as the other gateway apparatus 124_1. Then, each apparatus constituting the system is equipped with a process sorting DB and a transmission destination conversion DB that store corresponding information.

According to such a configuration, since a virtual network 181 may be realized by abstracting the communication protocols of the networks 122_1, 122_2, 122_3 as well, each apparatus is able to perform communication without consideration of the actual communication protocols.

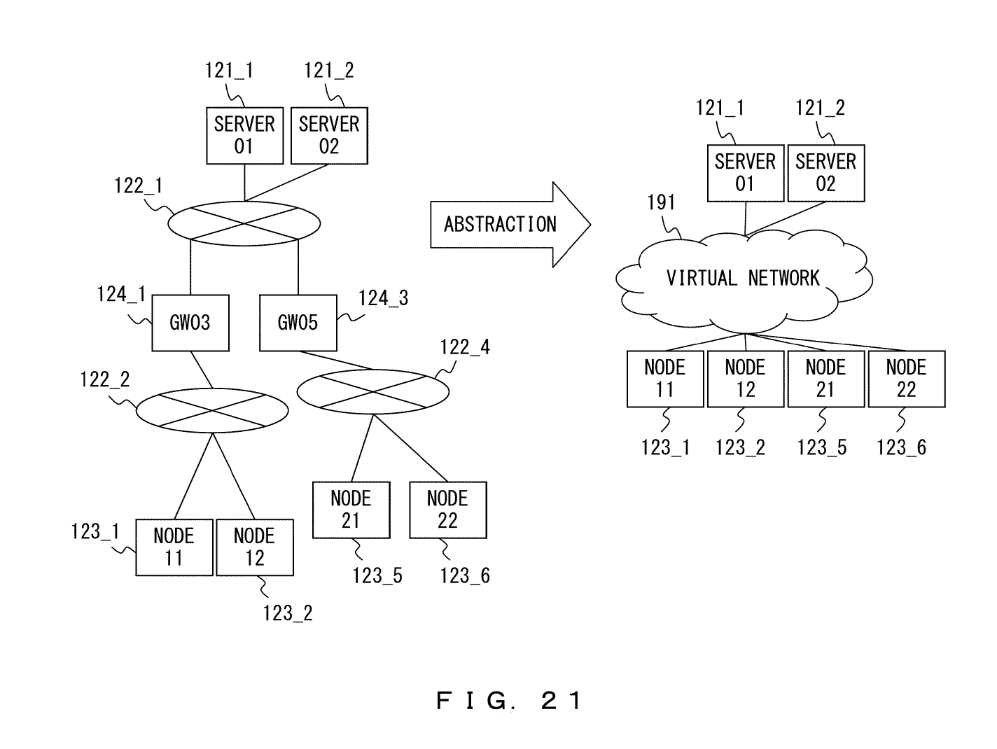

FIG. 21 is a second diagram illustrating another configuration example of the system according to the present embodiment.

The system in the configuration example illustrated in FIG. 21 is in a configuration equipped with a gateway apparatus for each communication protocol of a different protocol stack. In this system, a network 122_1 including two server apparatuses 121_1, 121_2 and a network 122_2 including node apparatuses 123_1, 123_2 are connected via a gateway apparatus 124_1. In addition, the network 122_1 and a network 122_4 including two node apparatuses 123_5, 123_6 are connected via a gateway apparatus 124_3. Here, in the network 122_4, the communication protocol of a third protocol stack that is different from the first and second protocol stacks is used. The two node apparatuses 123_5, 123_6 have the same configuration as the other two node apparatuses 123_1, 123_2 except that it is equipped with a third protocol stack instead of the second protocol stack. In addition, the gateway apparatus 124_3 also has the same configuration as the other gateway apparatus 124_1 except that it is equipped with a third protocol stack instead of the second protocol stack. Then, each apparatus constituting the system is equipped with a process sorting DB and a transmission destination conversion DB that store corresponding information.

According to such a configuration, since a virtual network 191 may be realized by abstracting the communication protocols of the networks 122_1, 122_2, 122_4 as well, each apparatus is able to perform communication without consideration of the actual communication protocols.

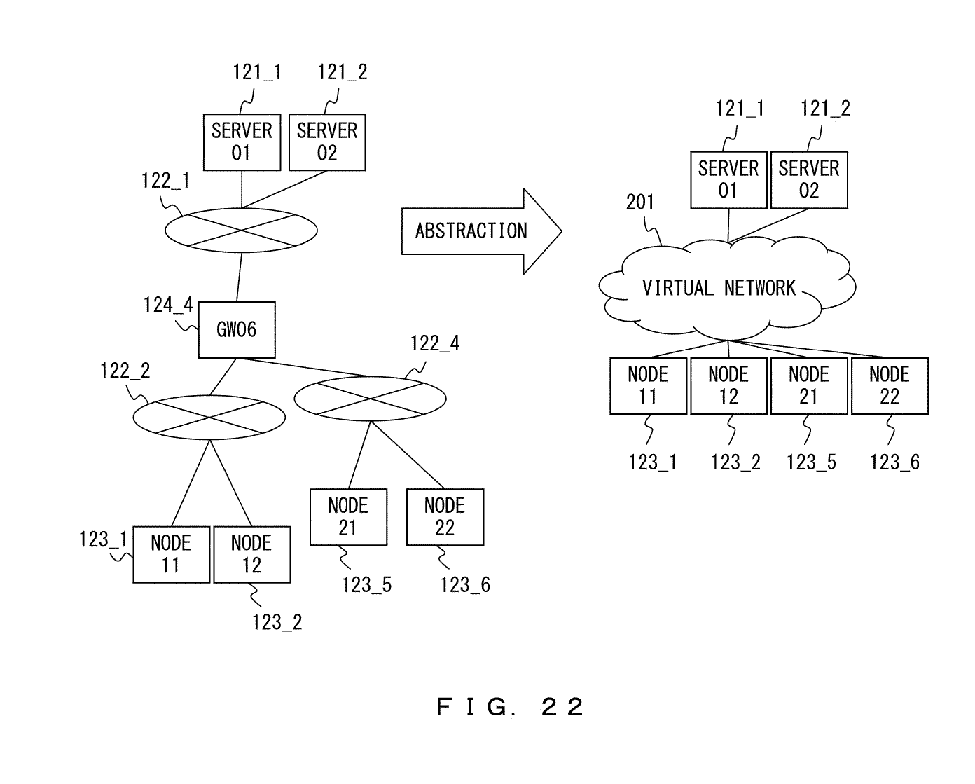

FIG. 22 is a third diagram illustrating another configuration example of the system according to the present embodiment.

The system of the configuration example illustrated in FIG. 22 is in a configuration in which three types of communication protocols are supported by one gateway apparatus. In this system, a network 122_1 including two server apparatuses 121_1, 121_2, a network 122_2 including two node apparatuses 123_1, 123_2, and a network 122_4 including two node apparatuses 123_5, 123_6 are connected via a gateway apparatus 124_4. In addition, accordingly, in the gateway apparatus 124_4, a third protocol stack is implemented in addition to the first and second protocol stacks. Then, each apparatus constituting the system is equipped with a process sorting DB and a transmission destination conversion DB that store corresponding information.

According to such a configuration, since a virtual network 201 may be realized by abstracting the communication protocols of the networks 122_1, 122_2, 122_4 as well, each apparatus is able to perform communication without consideration of the actual communication protocols.

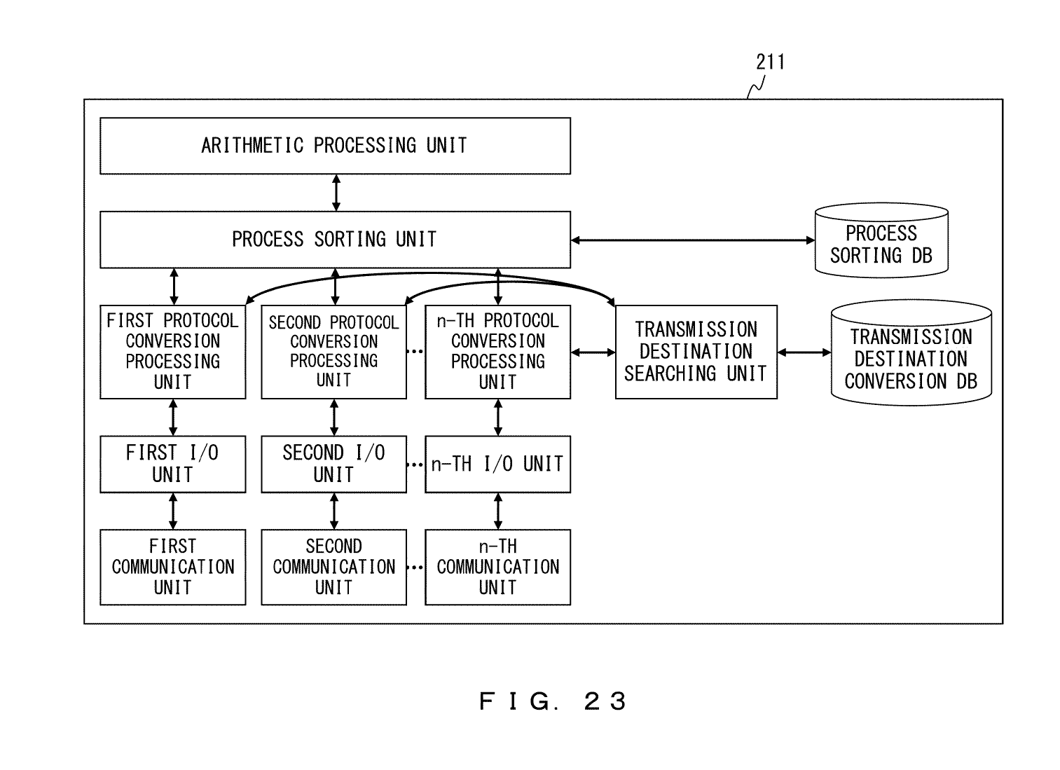

In addition, in the system according to the present embodiment, according to the configuration of the system, it is also possible to configure the gateway apparatus as illustrated in FIG. 23 through FIG. 26.

FIG. 23 illustrates a configuration example of the gateway apparatus in a case of supporting three or more types of communication protocols. In this case, the gateway apparatus 211 is equipped with a protocol conversion processing unit, an I/O unit, a communication unit for each communication protocol (protocol stack). Such a configuration is applied to the gateway apparatus 124_4 of the system illustrated in FIG. 22 for example,

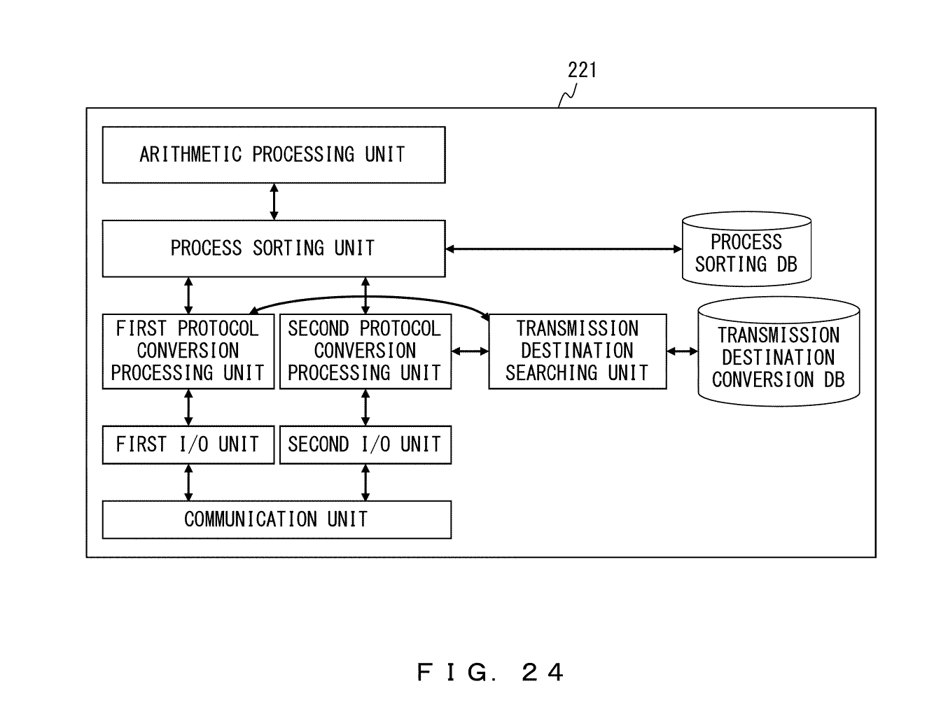

FIG. 24 illustrates a configuration diagram of a gateway apparatus in a case of supporting two types of communication protocols with the same physical layer but with different protocol stacks. In this case, the gateway apparatus 221 is equipped with a protocol conversion processing unit and an I/O unit for each communication protocol (protocol stack), but as for the communication unit, only one is provided and shared for the respective communication protocols. In this case, for example, one of the I/O units (first I/O unit) is a driver for IPv4 (Internet Protocol Version 4), and the other I/O (second I/O) is a driver for IPv6 (Internet Protocol Version 6).

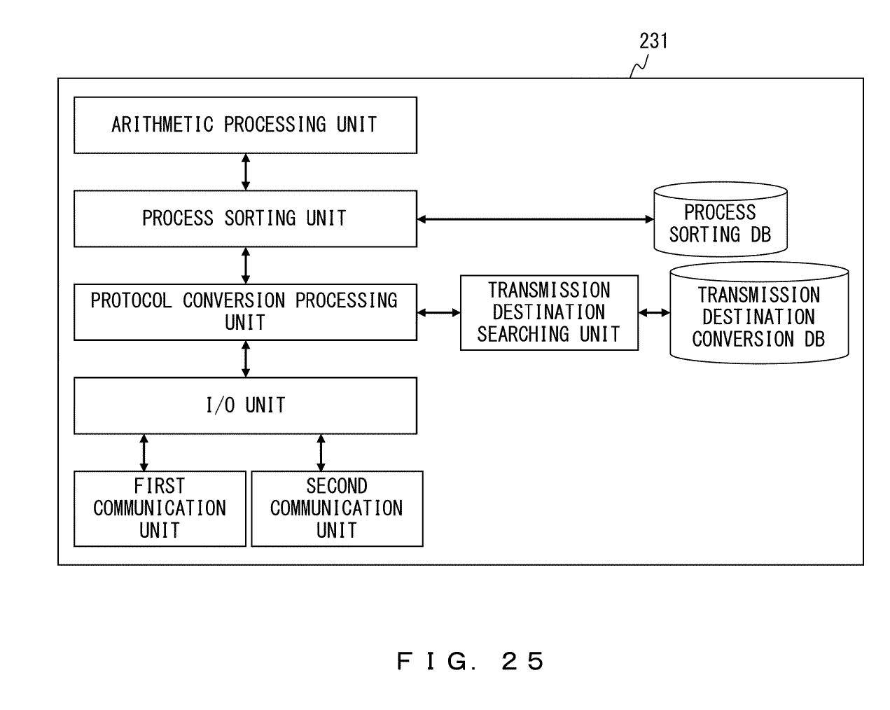

FIG. 25 illustrates a configuration example of a gateway apparatus in case of supporting one type of communication protocol but a plurality of communication units are provided. Here, as an example, an example of a case in which two communication units are provided is illustrated. In this case, the gateway apparatus 231 is equipped with one protocol conversion processing unit and I/O unit each, and two communication units. In this case, the two communication units are both an Ethernet board for example.

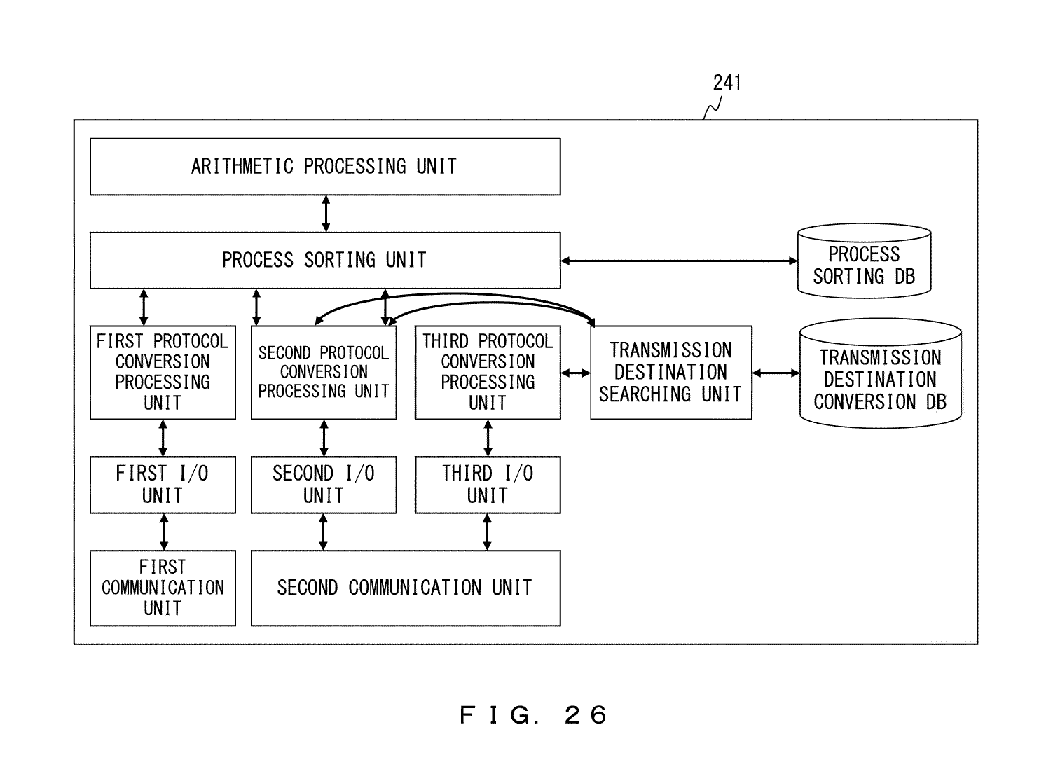

FIG. 26 illustrates a configuration example of the gateway apparatus of a case in which the configuration examples illustrated in FIG. 23, FIG. 24 are combined. Here, as an example, a case in which three types of communication protocols are supported, two of which are with the same physical layer but with different communication protocol stacks, is illustrated. In this case, gateway apparatus 241 is equipped with a protocol conversion processing unit and an I/O unit for each communication protocol (protocol stack), and with a communication unit for each of the different physical layers. In this case, the I/O unit (first I/O unit) corresponding to the protocol stack whose physical layer is not the same is a driver for TCP/IP for example. Meanwhile, the I/O unit (second I/O unit) corresponding to one of the two protocol stacks with the same physical layer is a driver for wireless ad-hoc communication protocol for example, and the I/O unit (third I/O unit) corresponding to the other is a driver for ZigBee for example. Meanwhile, the communication unit (first communication unit) corresponding to the protocol stack whose physical layer is not the same is an Ethernet board for example, and the communication unit (second communication unit) corresponding to the two protocol stack with the same physical layer are a wireless communication module for example. Such a configuration is applied to the gateway apparatus 124_4 in the system illustrated in FIG. 22 for example.

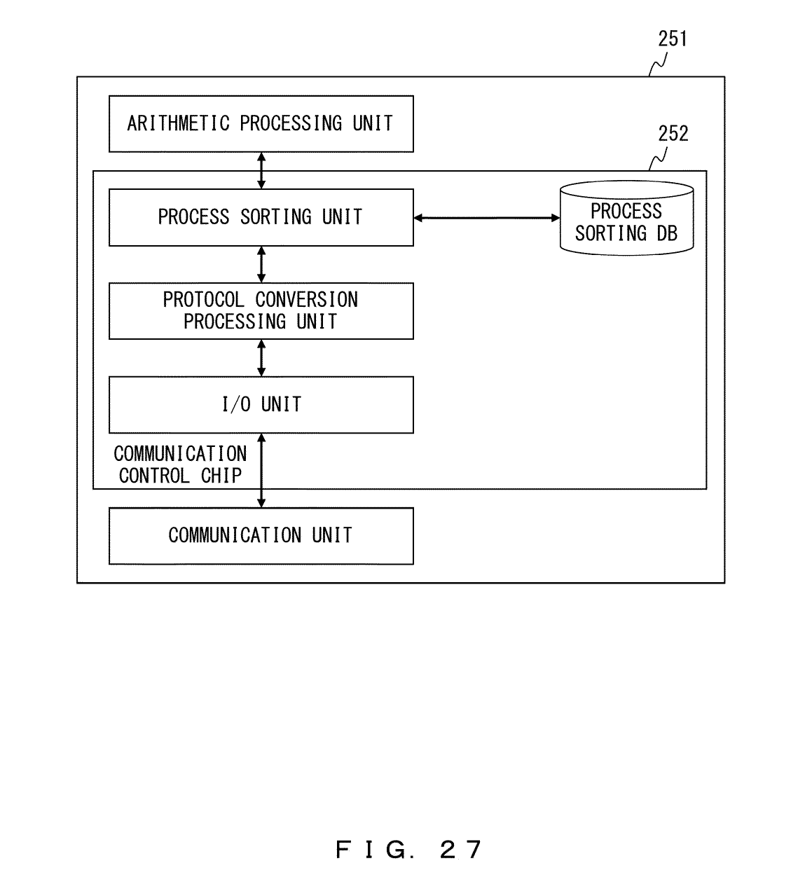

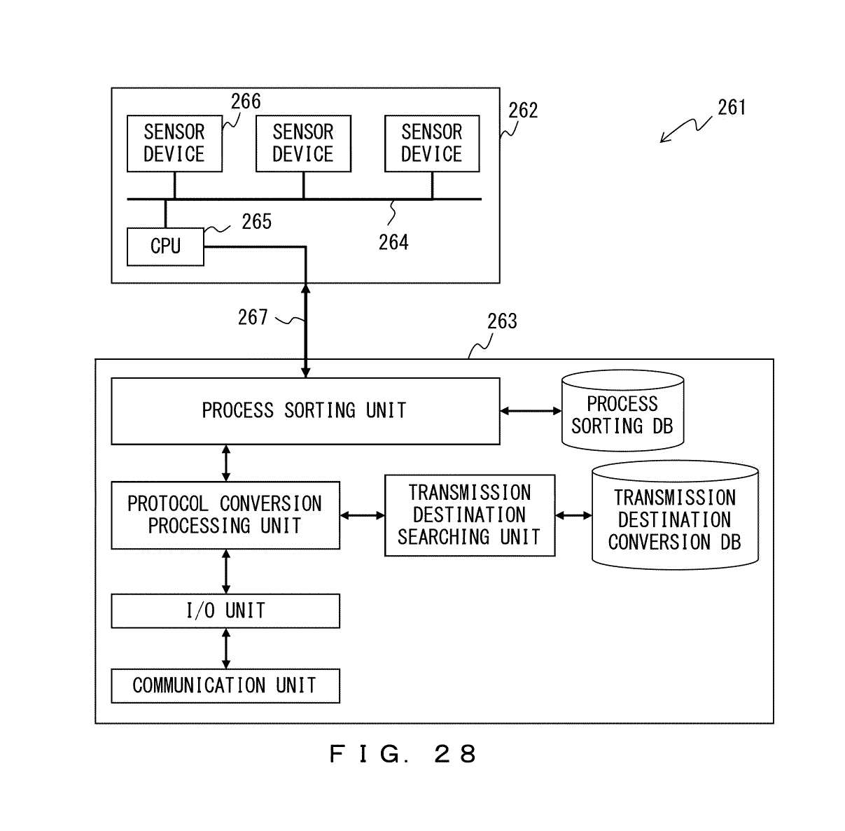

Meanwhile, in the system according to the present embodiment, according to the configuration of the system, it is also possible to configure the node apparatus as illustrated in FIG. 27 and FIG. 28 for example.

FIG. 27 illustrates a configuration example of the node apparatus in a case in which a part of configuration is made into a chip. In this case, in the node apparatus 251, the process sorting unit, the process sorting DB, the protocol conversion processing unit, the I/O unit are made into a chip, and they are configured as a communication control chip 252. Meanwhile, here, a case in which the communication protocol of the protocol stack implemented on the node apparatus 251 is the wireless ad-hoc communication protocol is assumed. In the wireless ad-hoc communication protocol, since transmission destination may be determined by the communication protocol, when the communication protocol is used, as illustrated in FIG. 27, a transmission destination searching unit and a transmission destination conversion DB is unnecessary.

FIG. 28 illustrates a configuration example of the node apparatus in a case in which a part of the configuration is made into a communication module. In this case, the node apparatus 261 is constituted by a general-purpose computer 262 such as a PC (Personal Computer) and a communication module 263. To a bus 264 of the general-purpose computer 262, in addition to a CPU (Central Processing Unit) 265, a plurality of sensor devices 266 and the like are connected. Here, the CPU 265 has a function of the arithmetic processing unit of the node apparatus. The communication module 263 includes a process sorting unit, a process sorting DB, a protocol conversion processing unit, a transmission destination searching unit, a transmission destination conversion DB, an I/O unit, a communication unit. Then, the CPU 265 of the general-purpose computer 262 and the process sorting unit of the communication module 263 are connected via a serial line 267 such as RS232C (Recommended Standard 232 version C).

Meanwhile, while it is not illustrated in the drawing, as another configuration example of the node apparatus, in the same manner as the gateway apparatus illustrated in FIG. 6 and FIG. 23 and the like, it is possible to make a configuration so that a plurality of protocol stacks are implemented, and the protocol conversion processing unit, the I/O unit, the communication unit are provided for each protocol stack.

Next, an application example of the system according to the present embodiment is explained.

The system according to the present embodiment may be applied to, for example, environment management (temperature management and the like) of a data center. In this case, a large number of sensors (temperature sensor etc.) placed on a server rack of a data center is integrated into a sensor network, and a monitoring server apparatus performs collective management. Accordingly, for example, by finely controlling the temperature adjustment of the air conditioning facility based on the sensor data, it becomes possible to reduce the overall power consumption of the data center, and the like.

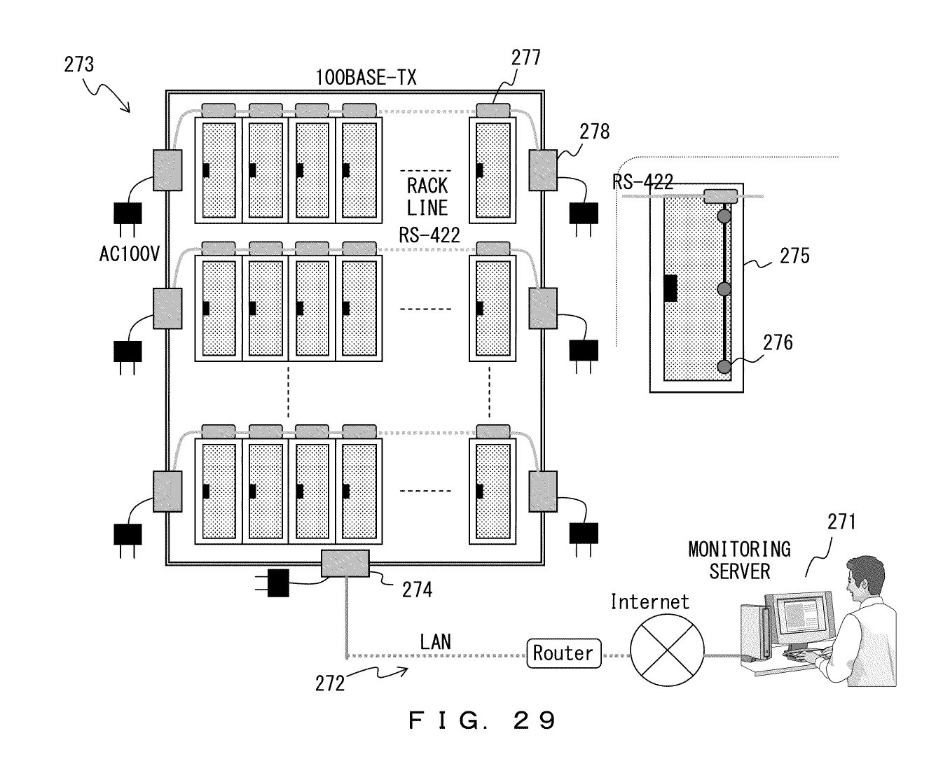

FIG. 29 illustrates an example in which the system according to the present embodiment is applied to the environment management of a data center.

As illustrated in FIG. 29, in this case, in the system according to the present embodiment, an IP net 272 including a monitoring server apparatus 271 that performs the environment management of the data center and a sensor network 273 are connected via a gateway apparatus 274.

In the sensor network 273, for the security problem due to radio wave leakage and for improving reliability of sensor data acquisition, a wireless network is not used, and a wired network is used. In the sensor network 273, on each server rack 275, a sensor node apparatus 276 equipped with a temperature sensor, and a sensor relay node apparatus 277 connected to the sensor node apparatus 276 are placed. In addition, the sensor relay node apparatuses 277 placed on the respective server racks 275 are connected in series for each rack line, and both ends of each are connected to the core relay node apparatus 278. Furthermore, the core relay node apparatuses 278 are connected in series in a ring-like manner, which is connected to the gateway apparatus 274. Here, the connection between the gateway apparatus 274 and the core relay node apparatus 278, and between the core relay node apparatuses 278 are a network compliant to the standard of 100BASE-TX, for example. Meanwhile, the connection between the core relay node apparatus 278 and sensor relay node apparatus 277, and the connection between the sensor relay node apparatuses 277 are a network compliant to the standard of RS422 (Recommended Standard 422), for example. Meanwhile, the connection between the sensor relay node apparatus 277 and the sensor node apparatus 276 are a network connected by serial communication.

In the system illustrated in FIG. 29, the communication protocols are different between the respective networks of the IP net, 100BASE-TX net, RS422 net, and the serial communication net. For this reason, in the respective apparatuses, the gateway apparatus 274, the core relay node apparatus 278, the sensor relay node apparatus 277, the protocol stacks of the corresponding two communication protocols are implemented.

In the monitoring server apparatus 271, as in the server apparatus 121 illustrated in FIG. 4, network middleware is provided in the implemented protocol stack. Meanwhile, in the respective apparatuses, the gateway apparatus 274, the core relay node apparatus 278, the sensor relay node apparatus 277, as in the node apparatus 124 illustrated in FIG. 4, network middleware is provided in the implemented protocol stack.

In the system illustrated in FIG. 29, communication such as a transmission of sensor data of the temperature sensor from the sensor node apparatus 276 to the monitoring server apparatus 271 via the sensor relay node apparatus 277, the core relay node apparatus 278, the gateway apparatus 274 is performed. Meanwhile, the configuration of the data center changes with every expansion and maintenance. According to the size of the data center, points of changes increase as well. Therefore, the configuration is dynamically detected, and furthermore, collection is performed with role-sharing between sensors in the vicinity.

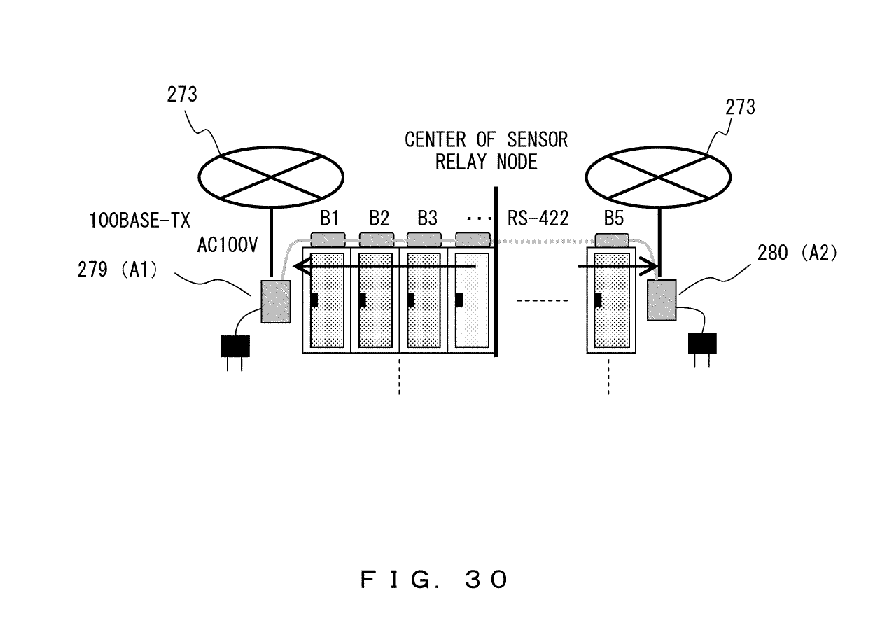

The system illustrated in FIG. 30 is an example in which, when transmitting sensing data of the sensor relay node apparatuses 277 connected in a line to the monitoring server 271, two core relay node apparatuses 278 performs the transmission with role-sharing. The ID of the core relay node apparatus 278 illustrated as A1, and the ID of the sensor relay node apparatus 277 are illustrated as A2.

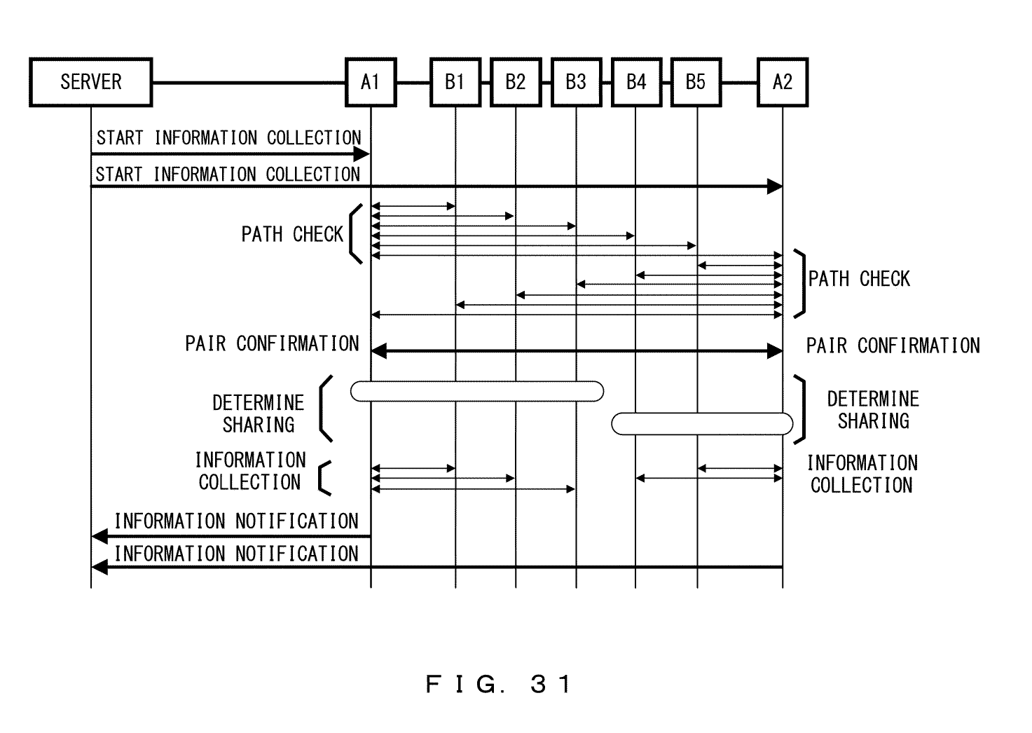

FIG. 31 is a sequence of sensor information collection control in the system configuration in FIG. 30. The sequence is explained in (1) through (6) illustrated below.

(1) A1, A2 receive a command of information collection from the server apparatus for which information collection is desired.
(2) A1 and A2 each obtains information of the path towards the B being the control target, and of information collection device connected to B.
(3) According to the content searched in (2), A1 and A2 confirm that there is a pair with each other.
The pair is a case in which the apparatus ID of A exists in the searched content. Specifically, the judgment is made possible as the apparatus types are different between A and B.
(4) When the confirmation of the pair was obtained in the check of the path, whether or not the communication with the pair may be performed in 100BASE-TX is checked.
(5) When the communication with the pair is OK, information collection sharing with the pair is determined. In this case, A1 performs collection about B1, B2, B3 and information collection devices connected to them, and A2 performs collection about B4, B5, B6 and information collection devices connected to them.
(6) After the sharing is determined, information collection is performed, and the result is send to the server apparatus.

Meanwhile, for example, the system according to the present embodiment may also be applied to damage detection and health evaluation of civil construction, mechanical structure, facility and the like. In this case, for example, a large number of sensors (sensor node apparatuses) placed on abridge or rail track are integrated into a sensor network, and a monitoring server apparatus performs collective management of sensor data.

Meanwhile, for example, the system according to the present embodiment may also be applied to the measurement of the amount of radiation in a radiation-contaminated area. IN this case, the sensor node apparatus is equipped with a radiation amount sensor and a GPS sensor and the like, and is configured to be capable of wireless communication using a wireless communication protocol such as the wireless ad-hoc communication protocol and ZigBee. Then, such a sensor node apparatus is dropped on the target area using a helicopter and the like. The large number of sensors (sensor node apparatuses) placed as described above are integrated into a sensor network, and a monitoring server apparatus performs collective management of sensor data. Meanwhile, in this case, as explained using FIG. 15 and the like, a process according to the addition of a sensor node apparatus is performed.

In addition, for example, the system according to the present embodiment may also be applied to the measurement of environment information (temperature and atmospheric pressure) using a mobile object. In this case, the sensor node apparatus is equipped with a sensor of the temperature and the atmospheric pressure and the like and a GPS sensor and the like, and for example, placed on a human, a bicycle, an automobile, and the like. Then, the sensors (sensor node apparatuses) placed as described above are integrated into a sensor network, and a monitoring server apparatus performs collective management of sensor data together with GPS data.

Next, as a variation example of the system according to the present embodiment, an example in which an IP net is established on a virtual network to be realized is explained.

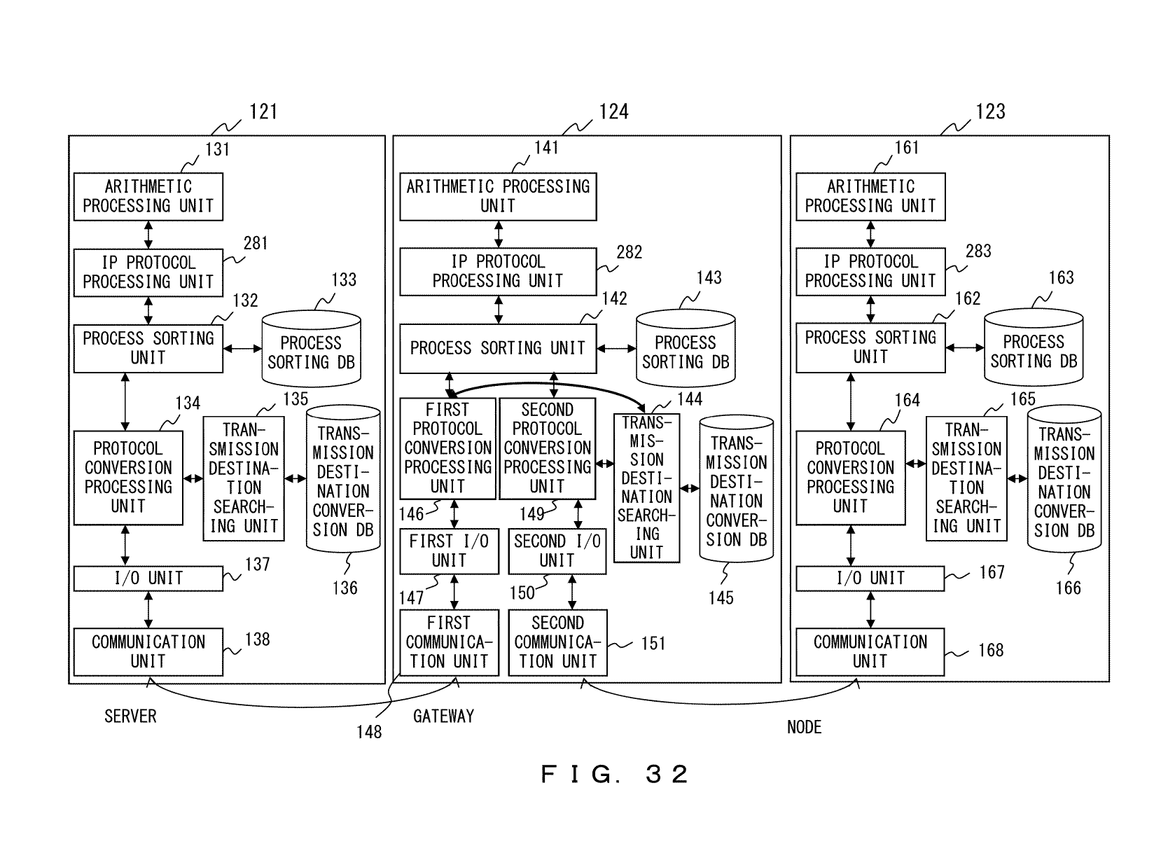

FIG. 32 illustrates a configuration example of the respective server apparatuses 121, the gateway apparatus 124, and the respective node apparatuses 123 included in a system according to the variation example.

In the system according to this variation example, each of the respective server apparatuses 121, the gateway apparatus 124, and the respective node apparatuses 123 has an IP address on a virtual network.

As illustrated in FIG. 32, each server apparatus 121 is equipped with an IP protocol processing unit 281 between an arithmetic processing unit 131 and a process sorting unit 132. In the same manner, the gateway apparatus 124 is also equipped with an IP protocol processing unit 282 between an arithmetic processing unit 141 and a process sorting unit 142. In the same manner, each node apparatus 123 is also equipped with an IP protocol processing unit 283 between an arithmetic processing unit 161 and the process sorting unit 162. Meanwhile, in the process sorting DB 133, of the each server apparatus 121, the process sorting DB 143 of the gateway apparatus 124, the process sorting DB 163 of each node apparatus 123, information of the sorting destination for the IP address and port number is stored as information of the sorting destination for a destination. In addition, in the transmission destination conversion DB 136 of each server apparatus 121, the transmission destination conversion DB 145 of the gateway apparatus 124, the transmission destination conversion DB 166 of each node apparatus 123, information of the destination for the IP address and port number is stored as information of the transmission destination for a destination. The configuration of each apparatus other than that is the same as the configuration of each apparatus explained using FIG. 5 through FIG. 7.

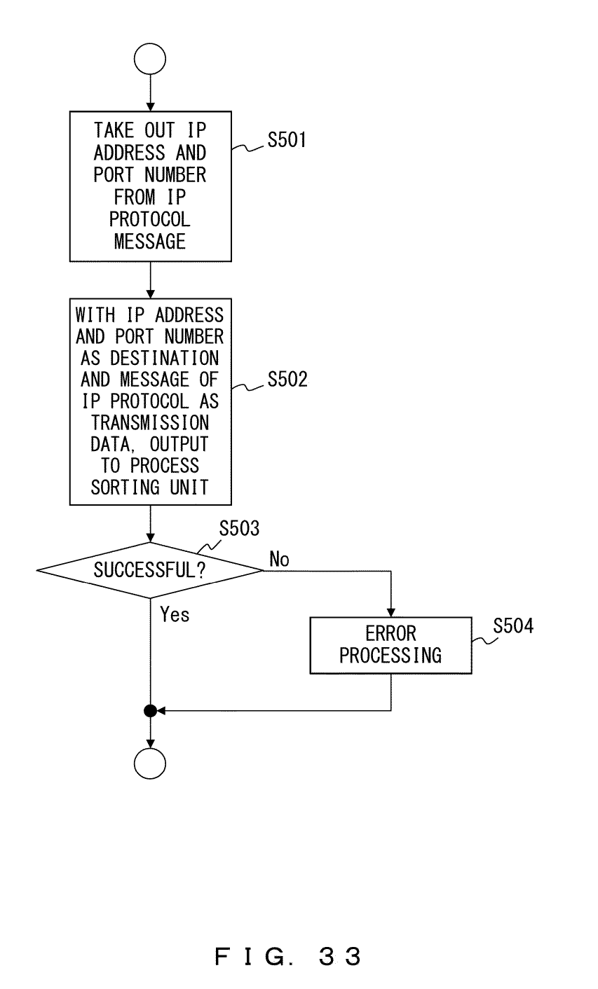

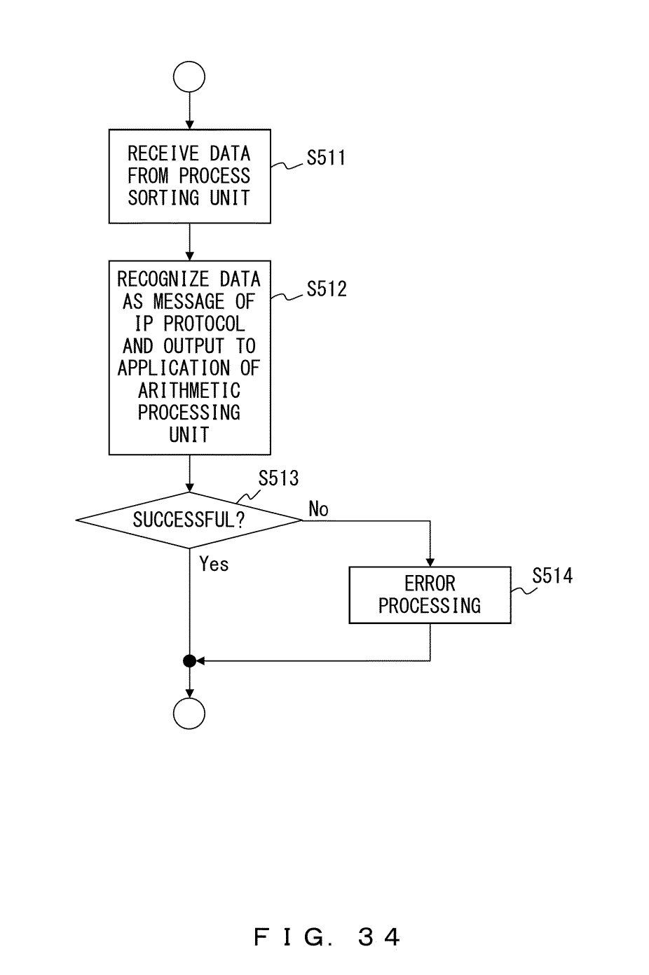

FIG. 33 is a first flowchart illustrating an operation example of the respective IP protocol processing units 281, 282, 283. FIG. 34 is a second flowchart illustrating an operation example of the respective IP protocol processing unit 281, 282, 283. Meanwhile, the operation of the respective IP protocol processing units 281, 282, 283 is the same operation in the corresponding apparatus.

As illustrated in FIG. 33, when a message of the IP protocol is input from the application run on the arithmetic processing unit is input, the IP protocol processing unit performs the following process.

First, the IP address and port number are taken out from the input message of the IP protocol (S501), and the message is output to the process sorting unit as transmission data, the destination of which is set to the IP address and port number (S502). Next, whether or not the output has been successful is judged (S503), and when the judgment result is Yes, the flow is terminated, and when it is No, an error process is performed (S504), and the flow is terminated.

Meanwhile, as illustrated in FIG. 34, when transmission reception data is input from the process sorting unit, the IP protocol processing unit performs the following process.

First, the transmission data is received (S511), and the transmission data is recognized as a message of the IP protocol, and is output to the application of the arithmetic processing unit (S512). Next, whether or not the output has been successful is judged (S513), and when the judgment result is Yes, the flow is terminated, and when it is No, an error process is performed (S514), and the flow is terminated.

By such a configuration, it becomes possible to establish an IP net on the virtual network to be realized.

For the system according to the variation example, a further variation as follows is also possible.

For example, a case in which a network in which a communication protocol that is different from the Internet protocol suite is used is further added and communication is performed relaying two or more of such networks is assumed. In such a case, the process may be performed in the same manner by linking the networks by a newly-added gateway apparatus.

In addition, in the system according to this variation example, since the configuration is made so that each server apparatus 121 and the gateway apparatus 124 originally performs communication using the communication protocol of the Internet protocol suite, it is also possible to configure them as follows.

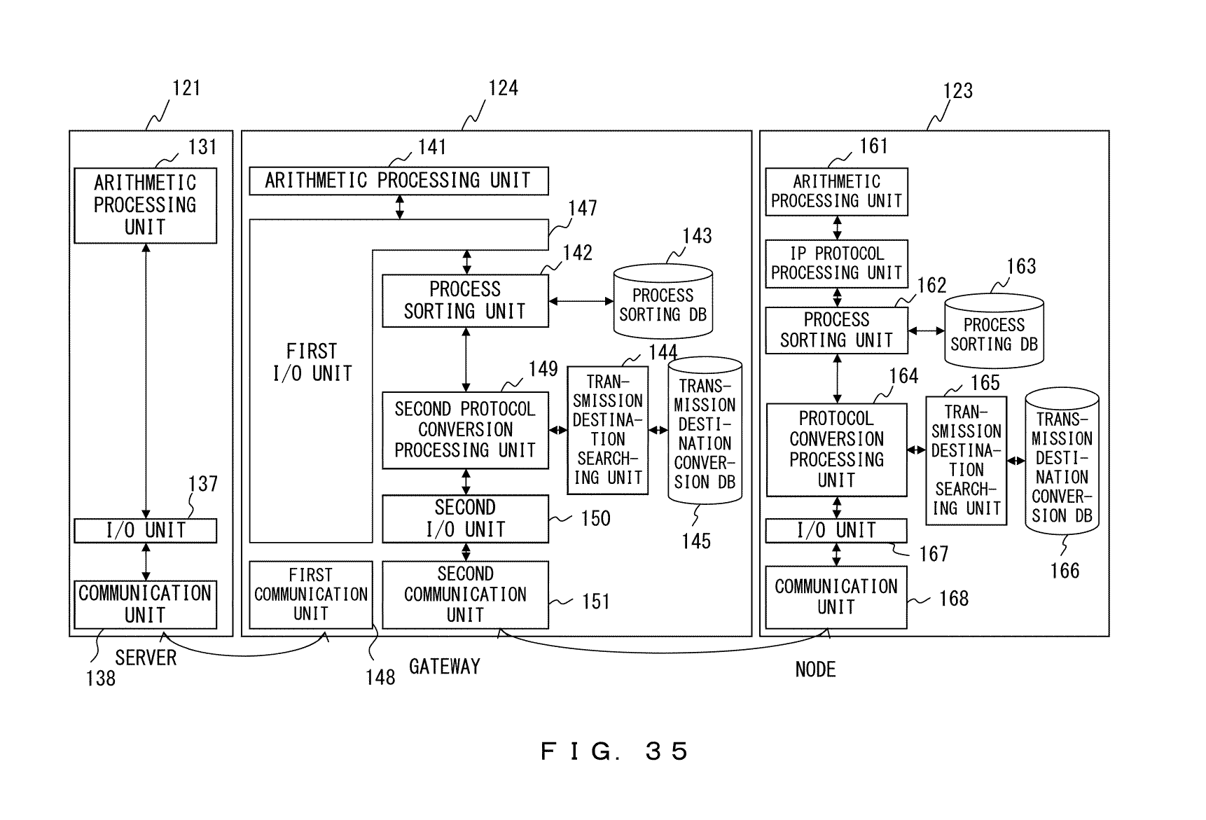

FIG. 35 is illustrates another configuration example of the respective server apparatuses 121, the gateway apparatus 124, the respective node apparatuses 123 included in a system according to the variation example.

As illustrated in FIG. 35, in this case, each server apparatus 121 is in a configuration in which the IP protocol processing unit 281, the process sorting unit 132, the process sorting DB 133, the protocol conversion processing unit 134, the transmission destination searching unit 135, the transmission destination conversion DB 136 are omitted. In addition, the gateway apparatus 124 is in a configuration in which the IP protocol processing unit 282, first protocol conversion processing unit 146 are omitted. In such a gateway apparatus 124, there is a routing function in the IP layer of TCP/IP, and in the communication to the node apparatus, the destination and transmission data are output to the process sorting unit 142.

Meanwhile, in the system according to this variation example, it is also possible to automatically assign an IP address on the virtual network as follows.

In this case, by combining the method to newly add an apparatus (a server apparatus, a gateway apparatus, anode apparatus) explained using FIG. 15 and the like, it becomes possible to automatically assign an IP address to a newly-added apparatus.

Specifically, a certain server apparatus 121 is made to be equipped with an application that makes the server apparatus 121 function as a DHCP (Dynamic Host Configuration Protocol) server apparatus, as an application which is performed on the arithmetic processing unit 131. Meanwhile, DHCP is a protocol of the application layer, and is a technique in which, on the DHCP server apparatus, some IP addresses are prepared in advance for the DHCP client, and according to the request from the DHCP client, an IP address is assigned from these.

When an apparatus is newly added, the process explained using FIG. 15 and the like is performed, and communication with another apparatus becomes available. That is, the communication on the virtual network becomes available. When it becomes like this, the newly-added apparatus sends out a UDP (User Datagram Protocol) packet of broadcast with destination IP address 255.255.255.255, according to the protocol of DHCP. A DHCP server apparatus 121 that has received the packet selects an IP address to be assigned from the prepared IP addresses, and returns it to the MAC (Media Access Control) address of the newly-added apparatus. Accordingly, an IP address is assigned automatically to the newly-added apparatus.

As described above, in the system according to this variation example, since an IP address may be automatically assigned to the apparatus to be newly added, when newly connecting a plurality of apparatuses to an IP net established on the virtual network, there is no need to manually perform network setting for each apparatus.

As described above, according to the system according to the present embodiment, the following effects are obtained.

Since a plurality of networks with different communication protocols may be virtualized, it is possible to perform communication between networks with different communication protocols without considering the communication protocols.

Meanwhile, in the system according to the present embodiment, for example, there may be a case in which the communication protocol used in a network is changed or in which a network of a different communication protocol is newly added. In such a case, just a change or addition of the corresponding protocol conversion processing unit, I/O unit, and communication unit in each apparatus (the server apparatus, the gateway apparatus, the node apparatus) will do. In this case, when the physical layer of the protocol stack which is to be changed or to be added is the same, just a change or addition of the corresponding protocol conversion processing unit and I/O unit will do.

Meanwhile, by commonalizing the interface with the process sorting unit and the protocol conversion processing unit and implementing the protocol conversion processing unit, the I/O unit and the communication unit as replaceable parts (module) in each apparatus (the server apparatus, the gateway apparatus, the node apparatus), the development of each apparatus becomes easy. In this case, when the physical layer of the protocol stack is the same, it is also possible to implement the protocol conversion processing unit and the I/O unit as replaceable parts.

Meanwhile, in the system according to the present embodiment, it is also possible to configure each apparatus (the server apparatus, the gateway apparatus, the node apparatus) as including a computer system described below, for example.

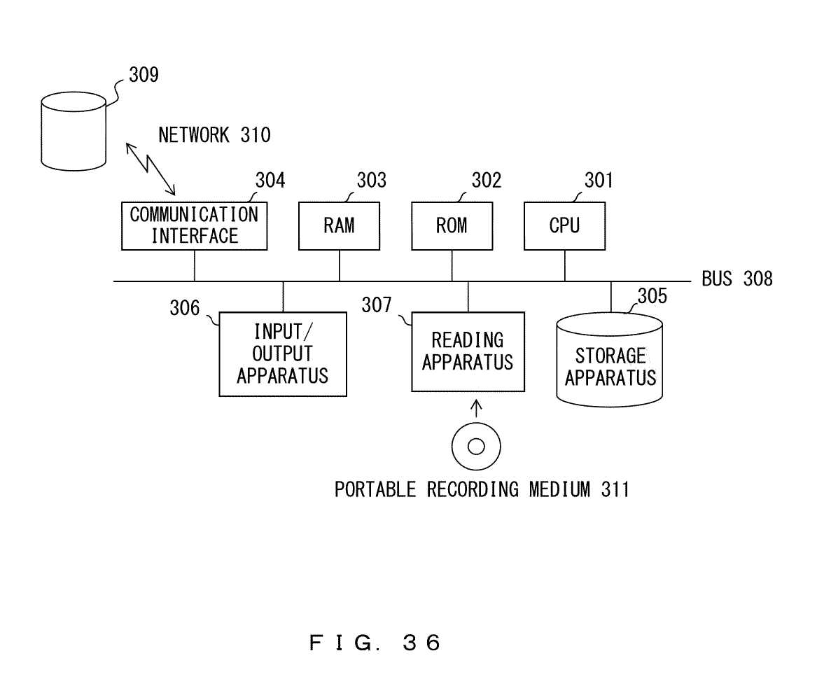

FIG. 36 illustrates a configuration example of the computer system.

The computer system includes a CPU 301, a ROM (Read Only Memory) 302, a RAM (Random Access Memory) 303, a communication interface 304, a storage apparatus 305, an input/output apparatus 306, a reading apparatus 307, and a bus 308 to which all of these are connected.

As the storage apparatus 305, storage apparatuses in various formats such as a hard disk, a magnetic disk and the like may be used. In the storage apparatus 305, or the ROM 302, a program and the like for the operation of the process sorting unit, the protocol conversion processing unit, the transmission destination searching unit, the I/O unit, the IP protocol processing unit and the like described above to be performed is stored. In addition, in the storage apparatus 305, or the ROM 302, information and the like stored in the process sorting DB, the transmission destination conversion DB is also stored. Then, with the program being executed by the CPU 301, the process sorting unit, the protocol conversion processing unit, the transmission destination searching unit, the I/O unit, the IP protocol processing unit and the like are realized.

It is also possible that such a program is executed by the CPU 301 while being stored in the storage apparatus 305 for example from a program provider terminal 309 via a network 310 and a the communication interface 304. Alternatively, it may also be executed by the CPU 301 while being stored in a portable storage medium 311 that are sold and distributed commercially, and being set in the reading apparatus 307. As the portable storage medium 311, storage media in various formats such as a CD-ROM, a flexible disk, an optical disk, an optical magnetic disk, a DVD disk, a USB memory and the like may be used. Meanwhile, the communication interface 304 corresponds to, for example, the communication unit of each apparatus.

The disclosed apparatus, method and system have an effect that communication may be performed between networks with different communication protocols, without consideration of communication protocols and without any special setting.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A gateway apparatus in which a plurality of protocol stacks are implemented and configured to mediate communication between a server apparatus and a node apparatus, in a communication system including a server apparatus, a node apparatus and a gateway apparatus, the gateway apparatus comprising:
a sorting destination storing unit which stores information of a sorting destination that performs a process according to a destination, for each destination;
a sorting unit which outputs an input destination and transmission data to a sorting destination according to the destination searched from information stored in the sorting destination storing unit;
a transmission destination storing unit which stores information of a transmission destination for each destination;
an input/output unit which is provided for each implemented protocol stack and performs a transmission process and a reception process according to a corresponding protocol stack; and
a protocol converting unit which is provided for each implemented protocol stack and assembles, when a destination and transmission data are input from the sorting unit, the destination and the transmission data as data that matches a format of a corresponding protocol stack, and instructs the input/output unit of a corresponding protocol stack to transmit the assembled data to a transmission destination according to the destination searched from information stored in the transmission destination storing unit.

2. The gateway apparatus according to claim 1, wherein
when data obtained by a reception process according to a corresponding protocol stack is input from the input/output unit of a corresponding protocol stack, the protocol converting unit extracts a destination and transmission data from the data, and outputs the destination and transmission data to the sorting unit.

3. The gateway apparatus according to claim 1, wherein
information of a sorting destination stored in the sorting destination storing unit includes information of a sorting destination for the protocol converting unit, and for an application of the gateway apparatus.

4. The gateway apparatus according to claim 1, wherein
information stored in the transmission destination storing unit is information that a transmission destination is an apparatus within a transmittable range by a communication protocol of an implemented protocol stack.

5. The gateway apparatus according to claim 2, wherein
with an application for management of a management server apparatus that manages an apparatus to be added to the communication system being a destination, information stored in the sorting destination storing unit includes the destination and a corresponding sorting destination;
with the application for management of the management server being a destination, information stored in the transmission destination storing unit includes the destination and a corresponding transmission destination; and
when a node addition notification is received from a new node apparatus, with the application for management of the management server apparatus being a destination, a first protocol converting unit corresponding to a protocol stack of the new node apparatus outputs transmission data being an addition message of the new node apparatus and the destination to the sorting unit; the sorting unit refers to the sorting destination storing unit based on the input destination of the transmission data, searches a second protocol converting unit corresponding to a protocol stack of the management server and outputs the destination and the addition message to the searched second protocol converting unit; and with the application for management of the management server apparatus being the destination, the second protocol converting unit assembles the input destination and addition message as data that matches the protocol stack of the management server apparatus, searches information of a transmission destination corresponding to the destination, and issues an instruction to a corresponding input/output unit for transmission.

6. The gateway apparatus according to claim 1, wherein
when, in a destination and transmission data input to the sorting unit, the destination is an update application of the gateway apparatus and the transmission data is a registration message of an apparatus, the sorting unit outputs the registration message to an update application run on the gateway apparatus, and the update application updates information stored in the sorting destination storing unit and the transmission destination storing unit, based on the registration message.

7. A communication method of a gateway apparatus in which a plurality of protocol stacks are implemented and configured to mediate communication between a server apparatus and a node apparatus, in a communication system including a server apparatus, a node apparatus and a gateway apparatus, the communication method comprising:
outputting a destination and transmission data to a sorting destination according to the destination;
when the destination is a prescribed sorting destination, assembling the destination and the transmission data as data that matches a corresponding protocol stack; and
transmitting the assembled data to a transmission destination according to the destination, after performing a transmission process according to a corresponding protocol stack.

8. The communication method according to claim 7, wherein
a reception process according to a corresponding protocol stack is performed for received data;
from data obtained by the reception process, a destination and transmission data are extracted; and
the extracted destination and transmission data are output to a sorting destination according to the destination.

9. The communication method according to claim 7, wherein
when a node addition notification is received from a new node apparatus, with an application for management of a management server apparatus managing an apparatus to be added to the communication system being a destination, transmission data being an addition message of the gateway apparatus and the destination are output to a sorting destination according to the destination.

10. The communication method according to claim 7, wherein
when outputting the destination and the transmission data to a sorting destination according to the destination, when the destination is an update application of the gateway apparatus, the transmission data is output to the update application; and
the update application updates information of a sorting destination and a transmission destination for each destination, based on the transmission data.

11. A node apparatus in which a protocol stack is implemented, the node apparatus comprising:
a sorting destination storing unit which stores information of a sorting destination for each destination;
a sorting unit which outputs an input destination and transmission data to a sorting destination according to the destination searched from information stored in the sorting destination storing unit;
a transmission destination storing unit which stores information of a transmission destination for each destination;
an input/output unit which is provided corresponding to an implemented protocol stack and performs a transmission process and a reception process according to a corresponding protocol stack; and
a protocol converting unit which is provided for an implemented protocol stack, and assembles, when a destination and transmission data are input from the sorting unit, the destination and transmission data as data that matches a format of a corresponding protocol stack, and instructs the input/output unit of a corresponding protocol stack to transmit the assembled data to a transmission destination according to the destination searched from information stored in the transmission destination storing unit.

12. The node apparatus according to claim 11, wherein
when data obtained by a reception process according to a corresponding protocol stack is input from the input/output unit, the protocol converting unit extracts a destination and transmission data from the data, and outputs the destination and transmission data to the sorting unit.

13. A communication method of a node apparatus in which a protocol stack is implemented, the communication method comprising:
outputting a destination and transmission data to a sorting destination according to the destination;
when the destination is a prescribed sorting destination, assembling the destination and transmission data as data that matches a format of a corresponding protocol stack; and
outputting the assembled data to a transmission destination according to the destination, after performing a transmission process according to a corresponding protocol stack.

14. The communication method according to claim 13, wherein
for received data, a reception process according to a corresponding protocol stack is performed;
from data obtained by the reception process, a destination and transmission data are extracted; and
the extracted destination and transmission data are output to a sorting destination according to the destination.

15. A communication system in which a first network including a server apparatus and a second network including a node apparatus are connected via a gateway apparatus; wherein
the server apparatus comprises:
a first sorting destination storing unit which stores information of a sorting destination for each destination;
a first sorting unit which outputs input destination and transmission data to a sorting destination according to the destination searched from information stored in the first sorting destination storing unit;
a first transmission destination storing unit which stores information of the transmission destination for each destination;
a first input/output unit which performs a transmission process and a reception process according to a first protocol stack of a communication protocol of the first network, the first protocol stack being implemented in the server apparatus; and
a first protocol converting unit which assembles, when a destination and transmission data are input from the first sorting unit, the destination and the transmission data as data that matches a format of the first protocol stack and instructs the first input/output unit to transmit the assembled data to a transmission destination according to the destination searched from information stored in the first transmission destination storing unit, and when data obtained by a reception process according to the first protocol stack is input from the first input/output unit, extracts from the data a destination and transmission data, and to output the destination and transmission data to the first sorting unit,
the node apparatus comprises:
a second sorting destination storing unit which stores information of a sorting destination for each destination;
a second sorting unit which outputs input destination and transmission data to a sorting destination according to the destination searched from information stored in the second sorting destination storing unit;
a second transmission destination storing unit which stores information of the transmission destination for each destination;
a second input/output unit which performs a transmission process and a reception process according to a second protocol stack of a communication protocol of the second network, the second protocol stack being implemented in the node apparatus; and
a second protocol converting unit which assembles, when a destination and transmission data are input from the second sorting unit, the destination and the transmission data as data that matches a format of the second protocol stack and instructs the second input/output unit to transmit the assembled data to a transmission destination according to the destination searched from information stored in the second transmission destination storing unit, and when data obtained by a reception process according to the second protocol stack is input from the second input/output unit, extracts a destination and transmission data from the data, and to output the destination and transmission data to the second sorting unit,
and the gateway apparatus comprises:
a third sorting destination storing unit which stores information of a sorting destination for each destination;
a third sorting unit which outputs input destination and transmission data to a sorting destination according to the destination searched from information stored in the third sorting destination storing unit;
a third transmission destination storing unit which stores information of the transmission destination for each destination;
a third input/output unit which performs a transmission process and a reception process according to the first protocol stack which is implemented in the gateway apparatus;
a fourth input/output unit which performs a transmission process and a reception process according to the second protocol stack which is implemented in the gateway apparatus;
a third protocol converting unit which assembles, when a destination and transmission data are input from the third sorting unit, the destination and the transmission data as data that matches a format of the first protocol stack and instructs the third input/output unit to transmit the assembled data to a transmission destination according to the destination searched from information stored in the third transmission destination storing unit, and when data obtained by a reception process according to the first protocol stack is input from the third input/output unit, extracts a destination and transmission data from the data, and outputs the destination and transmission data to the third sorting unit; and
a fourth protocol converting unit which assembles, when a destination and transmission data are input from the third sorting unit, the destination and the transmission data as data that matches a format of the second protocol stack and instructs the fourth input/output unit to transmit the assembled data to a transmission destination according to the destination searched from information stored in the third transmission destination storing unit, and when data obtained by a reception process according to the second protocol stack is input from the fourth input/output unit, extracts a destination and transmission data from the data, and to output the destination and transmission data to the third sorting unit.

16. The communication system according to claim 15, wherein
information stored in the first sorting destination storing unit includes information that a sorting destination for a destination being a first application of the server apparatus is the first application, and information that a sorting destination for a destination being a second application of the node apparatus is the first protocol converting unit;
information stored in the second sorting destination storing unit includes information that a sorting destination for a destination being the first application of the server apparatus is the second protocol converting unit, and information that a sorting destination for a destination being the second application of the node apparatus is the second application; and
information stored in the third sorting destination storing unit includes information that a sorting destination for a destination being the first application of the server apparatus is the third protocol converting unit, and information that a sorting destination for a destination being the second application of the node apparatus is the fourth protocol converting unit.

17. The communication system according to claim 15, wherein
information stored in the first transmission destination storing unit includes information that a transmission destination for a destination being the second application of the node apparatus is the gateway apparatus;
information stored in the second transmission destination storing unit includes information that a transmission destination for a destination being the first application of the server apparatus is the gateway apparatus; and
information stored in the third transmission destination storing unit includes information that a transmission destination for a destination being the first application of the server apparatus is the server apparatus, and information that a transmission destination for a destination being the second application of the node apparatus is the node apparatus.
